(19) United States
(12) Patent Application Publication
(10) Pub. No.: US 2002/0057915 A1
(43) Pub. Date: May 16, 2002

(54) Method and apparatus for enhancing personal safety with conspicuously concealed, incidentalist, concomitant, or deniable remote monitoring possibilities of a witnessential network, or the like

(76) Inventor: W. Stephen G. Mann, Toronto (CA)

Correspondence Address: W. Stephen G. Mann, 284 Bloor Street West, Suite 701, Toronto, ON, M5S 3B8, CA

(21) Appl. No.: 09/945,879

(22) Filed: Sep. 5, 2001

(30) Foreign Application Priority Data
Oct. 29, 1998 (CA) 2,248,473
Dec. 31, 1998 (CA) 2,256,922
Mar. 15, 1999 (CA) 2,264,973
Jul. 28, 1999 (CA) 2,280,022

(51) Int. Cl. G03B 1/00

(52) U.S. Cl. 396/661

(57) ABSTRACT

A portable personal safety device or a method of doing business by providing appropriate services, networks, or the like for the device, which has a possibility or the perception of a possibility of being monitored by an entity outside of the user's control, is disclosed. Preferably the user either does not know whether or not this possibility is fulfilled, or can credibly deny knowing whether or not this possibility is fulfilled. The apparatus, in one embodiment, comprises a conspicuously concealing container with optical properties suitable for a video camera, the actual presence of which is, in at least one mode of operation, unknowable by the user, or can be credibly alleged by the user to be unknowable or unknown by the user. In one embodiment, the device affords the user with a nonconfrontational or collegial means of asserting fear of accountability, uncertainty, or doubt on persons exerting physical or other coercive force, or the threat or possibility thereof, upon the user of the invention. In another embodiment of the invention, actual or apparent user submissiveness to a large organization is built into the apparatus or the method, so that the user of the invention can reduce his or her freewill, or apparent freewill, to a level that matches that of a member of a large organization. The apparatus, in many embodiments, provides the user with means for self demotion, from a willnot, to maynot, to cannot hierarchy. The invention provides an incidentalist possibility of evidence capture, so that legitimate officials are less offended by a user of the invention who might otherwise be perceived as disrespectful by videotaping or photographing or otherwise documenting the activities of force or coersion bearing persons or establishments, especially when these persons or establishments are authority figures, gang leaders, or the like.

### FIELD OF THE INVENTION

The present invention pertains generally to a portable apparatus or a means, apparatus, or method of enhancing personal safety.

### BACKGROUND OF THE INVENTION

In today's society which many allege is teeming with dangerous criminals, buildings often have sophisticated access control to make sure that everyone entering the establishment is properly processed, but those wearing uniforms, such as the officials operating these establishments, may often escape a means of being similarly held accountable for their actions.

Security forces, guards, police, and other officials often monitor a civilian population with video surveillance. For example, a security guard may carry a hand held video camera and videotape peaceful demonstrations and other peaceful activity, at which point those being videotaped often do not have an articulable basis upon which to complain or object.

However, when these same individuals observe misconduct of police officers, security guards, customs officials, gambling casino owners, drug kingpins, or other persons in a position of power or authority, and attempt to videotape or photograph instances of such misconduct, their cameras are frequently smashed, broken, or siezed, and sometimes the persons are brutalized or even murdered.

Moreover, building owners have developed means and apparatus for surveillance of individuals passing through their establishments, yet security forces will often attack any civilians who take photographs or videos within their establishments. The most notable examples of such establishments are gambling casinos, brothels, bordellos, opium dens, crack houses, and other places such as totalitarian regimes where surveillance is used extensively but outside scrutiny is unwelcome.

Other forms of access control, such as card readers, etc., are a well known aspects of the prior art. The field of biometrics is also well established, through a number of scholarly conferences describing a future in which security forces and other officials can know the whereabouts and activities of most other individuals at all times.

In addition to access control, there are also perimeter security devices such as that disclosed in U.S. Pat. No. 5,182,764 to scan individuals for weapons, and other forms of devices that allow officials or security guards to see through clothing to inspect individuals. Some systems allow officials to secretly search individuals without their knowledge or consent, and without any kind of due process.

Business models, and methods of processing and monitoring individuals passing through official spaces, buildings, offices, prisons, and the like, are well known in the art of record.

However, the art of record for the protection of the individual person, personhood, and personal space, is somewhat lacking. Although physical protection of the body through armour is a centuries-old aspect of the prior-art, dating back to the days when five to seven layers of rhinoceros skin were used to protect the body during battle, such physical protection of the body has not kept pace with informatic developments in protection of property as we evolve from a physical world to an informatic world.

Although protection of property has evolved from medieval fortresses toward bank towers with glass doors protected by card readers and retinal scanners, the protection of the body has not kept pace with the move from physical stone fortresses to more the informatic protection of buildings.

Additionally, in part because of the occasionally discovered and publicized crime and corruption of some law enforcement officials (some of which extends to very high levels within the organizations), the honest law enforcement officials are often falsely accused of wrongdoing. Thus a personal safety device for being used by police officers, medical practitioners, and the like, could help solve this problem, and at the same time provide some additional degree of accountability that might also make economic sense in terms of underwriting of insurance policies.

Unfortunately, in many situations, the mere presence of a video camera results in immediate violence directed to a person with a camera. Thus hand-held cameras often serve to provoke rather than deter violence.

This violence directed at camera operators is almost globally universal, and can be observed in nearly any country. When trying to use a camera to collect evidence of wrongdoing, even otherwise mild mannered clerks will sometimes jump over a counter and punch a camera operator in the face, knocking the camera to the ground. Even in countries like Canada which is said to have a very good Human Rights record camera operators have been physically assaulted and unlawfully detained, for example, by Shell gas station attendants, for merely using a hand-held camera to collect evidence of wrongdoing. Resonses to cameras are documented, for example, in various mpeg movies linked from http:///wearcam.org/shootingback.html.

Additionally, the use of cameras can sometimes actually intensify violence that is already present, when the explicit use of cameras angers the authorities or other perpetrators of this violence.

### SUMMARY OF THE INVENTION

Incidentalist image capture, as well as incidentalist image capture possibility can be used to deflect violence that might otherwise happen with more confrontationally hand-held cameras.

It was found that officials who reacted violenty to hand held cameras, did not seem to have an articulable objection to having their pictures or activities captured using an incidentalist imaging system, such as a wearable system in which the use of the camera was incidental to another activity such as simply appearing to be doing a job (as in wearing a uniform).

Wearable cybernetic personal imaging systems, such as EyeTap devices, described in http://eyetap.org, transmitting realtime video to the Internet are also good examples of incidentalist imaging systems, and have been used to document riot police, customs officials, and others who would normally object to being held accountable by way of hand-held video cameras, or the like. The nonconfrontational nature of this interaction, described in an article entitled “Can Humans Being Clerks make Clerks be Human?” by S. Mann, in Informationstechnik und Technische Informatik, Volume 43, Issue 02, 2001, p. 97-106, ISSN 0944-2774 (http://wearcam.org/itti/), is called incidentalist image capture.

Some people have tried to explain this phenomenon by merely stating that the perpetrators did not know that the EyeTap device has camera-like properties, or even what the EyeTap device was.

Thus a series of experiments were conducted in which it was made very obvious that the EyeTap device was transmitting live video.

This was done by attaching a very large flat screen television to the body and having it running a web browser, mirroring images from the website receiving the signals from the EyeTap device.

To make it even more obvious it was transmitting, a flashing red light, and flashing indicia bearing terms such as “REC.” (the common abbreviation for “record” regardless of language), were included together with making the transmitting antenna more obvious, and having words like “LIVE BROADCAST” (in the appropriate language of the country where used) flash across the screen in large letters.

A freeze frame effect was also used, so that the otherwise would-be perpetrator could see his face on the wearable television screen in larger-than-life size.

Moreover, in case would-be perpetrators might not have believed that the devices were actually capable of transmitting video, some experiments/performances were done with one person wearing a transmitting device, and another person receiving the images and browsing them on a wearable web browser to show to the subject of the experiment or performance.

For example, in some situations, the web browsers were shown to high level officials (such as the director of security) in an establishment where photography was strictly prohibited. When blatantly showing such officials pictures of themselves received on portable web browsers, it was, quite surprisingly, found that approximately 9 times out of 10, the officials did not object to having their pictures taken, even when it was explained to them that these pictures were being transmitted onto the Internet and backed up in several different countries around the world.

Additionally, various performances and experiments were conducted using devices having varying degrees of obviousness, and varying degrees of camera-like appearances. A range of overtness is quite possible, ranging from a completely hidden camera to a very obvious camera. It was found that the best balance between deterrence (making the camera obvious) and ambiguity (making the camera less obvious) could be struck by making what is known as a “blatantly covert” camera. Such a blatantly covert camera is obtained through conspicuous concealment.

Moreover, it is not necessary to actually have a camera present, to attain deterrence. A conspicuously concealed imaging possibility is quite sufficient. A conspicuously concealed imaging possibility may be referred to as a maybe camera.

Hundreds of different kinds of “maybecameras” were constructed in varying degrees of obviousness, some being more provocatively “conspicuously concealed” than others. Insights gained in these experiments formed the basis for the design of a Witnessential Network (TM) of devices that have the appearance that cameras could be concealed in them, but are nevertheless very fashionable.

The use of conspicuously concealed imaging possibilities forces would-be human rights violators or perpetrators of violence to choose between accepting the possibility of accountability, or appearing exceedingly paranoid.

Imaging possibilities may be conspicuously concealed behind smoked acrylic, smoked polycarbonate, or the like. Smoked acrylic, smoked polycarbonate, or the like can also be sculpted into very nice jewelry and fashion accessories, or articles for being sewn onto backpacks, satchels, clothing, or even being directly bonded to the human body, for example, with Dermabond (TM) which is commonly used for surgery and repair of wounds.

The use of clothing, and especially Dermimplants (TM), forces would-be human rights violators or perpetrators of violence to make a choice between accepting the possibility of accountability, making an exceedingly unreasonable request (such as asking the victim to remove clothing, or to accept physical damage to the body to remove the body modification of the invention).

With widespread usage of the invention, a would be perpetrator would need to strip down everyone and start to attack the corporeal space of many in order to be certain their criminal acts could proceed without risk of being documented. Nothing short of ethnic cleansing or mass decontamination (as described in http://existech.com/tpw/index.html) could begin to address this “problem” that such criminals would face.

Experiments/performances documented in this body of work suggests that in addition to covert wearable image capture devices, that a more overt and obvious form of image capture device, as well as conspicuously concealed devices may be useful as a new form of protection of civil rights, freedom, and democracy. Such is the role of the World Subjectrights Day performances (http://wearcam.org/wsd.htm).

When engaging in such civil accountability performances, using devices such as the “maybe cameras”, it is preferable that large numbers of persons participate so that certain individuals are not singled out as victims of violence or state-sponsored terrorism.

Not all of us regularly encounter systematic violence, such as torture or mass murder, in our daily lives. A more common kind of situation many of us might encounter, is when a person tries to negotiate with a used car salesman, and the used car salesman might say something like “I'd love to give you the car for one thousand dollars; let me check with my manager”. The used car salesman then disappears into a back room, has a coffee, and reads a newspaper for a few minutes, and then comes out and says “I'd love to give you the car for one thousand dollars but my manager won't let me.”. Although the salesman never talked to a manager, the salesman has some degree of power over the customer by virtue of being able to credibly pretend that he is bound by a higher authority. A credible, articulable, higher and unquestionable authority allows representatives of organizations to obtain external blame and excuses for their otherwise irrational or disagreeable actions.

Unfortunately the individual person does not ordinarily enjoy the same luxury as the clerk, and must therefore behave more rationally, or risk seeming irrational, rude, or otherwise inappropriate. For example, if an individual carried a handheld video camera around videotaping clerks, casino operators, police officers, customs officials, and the like, the individual might be regarded as strange, rude, or otherwise acting in an inappropriate manner.

The individual could rely on religion, as a manager, by, for example, wearing a camera contraption as part of a religious order. Just as religion allows individuals to wrap their heads in various materials that would otherwise be regarded as inappropriate, a new religion such as the “personal safety religion” could be invented, that required its members to wear cameras.

Thus religion could form a similar purpose to the manager for the individual, but there is the danger that others (including clerks) may dismiss the individual as a religious fanatic. Therefore, what is needed is a similar way for the individual to have excuses for and to externalize blame for otherwise irrational or disagreeable actions. Alternatively, artistic freedom is useful in this regard.

An important aspect of a Witnessential Network is for the individual to be able to nonconfrontationally inflict fear of accountability, uncertainty, or doubt on persons exerting physical or other coercive force, or the threat or possibility thereof, upon the user of the invention. This can be done by way of an incidentalist imaging possibility. In particular, a collegial form of disobedience to authority, in the form of what is, or appears to be, an incidentalist act, can be generated by the apparatus of the invention, where an overtly certain act of disobedience would be forbidden.

Incidentalist imaging refers to imaging which can be made to seem as if it occurs merely by chance or without intention or calculation. An incidentalist imaging system may in fact blatantly capture images (as by an articulable requirement from a higher authority to do so), or it may present itself as a device that could capture images in a way in which it is difficult to discern the intentionality of the use of the invention.

In addition to incidentalism, another similarly desirable property for minimization of confrontation with would-be perpetrators is self-demotion. This is done by creating a situation of a user of the invention who is able to either be, or pretend to be, under the control of a Safety Management Organization (SMO). Thus the Witnessential Network is able to help hold a Police State accountable for its actions. The Witnessential Network enables the individual to be empowered by self-demotion, in the same way that clerks in a Police State facilitate empowerment of large organizations. The self-demotion provides a deliberate self-inflicted dehumanization of the individual that forces the clerk to become human. An important principle of self demotion is basically that humans being clerks can make clerks be human.

A user of the invention can choose to be bound by (or to pretend to be bound by) an SMO that is itself bound by a higher authority such as an insurance company. Thus, in one embodiment, the user can, for example, take out a life insurance policy that requires him or her to wear a personal safety device that recorded video at all times, or to wear a conspicuously concealed imaging possibility that may or may not contain a video camera.

A method of doing business can be provided by the invention, in which the user does not know whether or not a camera is present in the invention. Thus when the user is asked by an official whether or not the user is wearing a camera, the user can reply: “I do not know sir. I've answered your question, I do not know.”.

Thus the life insurance company provides the individual with a means for articulably externaizing his or her own irrational actions. The individual can also say “I'm wearing this device because my manager (SMO) requires it, and the insurance company requires the SMO to require me to wear it”, etc.

Such a nice complicated chain of command allows the individual to self-bureaucratize. Moreover, by situating the head office of the insurance company abroad (e.g. Facility Garden in Hong Kong, for policy holders in North America) a more complicated bureaucratizer is created.

Preferably, in the experimental apparatus, a proceduralizer is also used to allow the individual to follow, or to appear to follow, a prescribed procedure without appearing to be thinking for himself or herself. The lack of apparent individual thought or intentionality, allows the individual to become or seem to become a clerk, which is what forces the clerk within the Police State to be human in being forced to think and make decisions for himself or herself.

Moreover, self-demotion can occur internally without the need for an external manager. An example of an embodiment of the invention based on internal self-demotion is when the wearer uses an involuntary bodily function such as measured by heart ECG electrodes, respiration sensors, and the like, to control a video capture process. In this way, the wearer can deny having any control over the process.

For example, the system may be configured so that images are only captured when heart rate or sweatiness index exceeds a certain threshold, compared to motion as sensed by the device.

If the wearer is being harassed by a prospective terrorist, the terrorist has only himself to blame for inducing the image capture by causing the wearer to be sweaty and her heart to beat more quickly.

In addition to the wearable portion of the apparatus of the invention, a network is needed, and is referred to as the Witnessential (TM) Network. A Witnessential Network has the following properties:

The witnessential nodes (for use by cyborgs) must be Incidentalist in the sense of being an embodiment of Incidentalist Video Capture;

The witnessential node must at least appear to be nonselective in what subject matter is captured, and for this reason, the witnessential apparatus should be within the Corporeal Envelope (e.g. be wearable or implantable), so that perpetrators of violence do not feel singled-out by the imaging possibility of the node;

The witnessential node must be “always readv” to remember incidents, e.g. the witnessential apparatus must run all the time, even when it is not being “used” (e.g. it must be a successful embodiment of Humanistic Intelligence as described in http://hi.eecg.toronto.edu/hi.htm), a Retroactive Record feature being essential to document surprise abductions or violence by middle-of-the-night “no knock entry” thugs;

The apparatus of the invention must be difficult to remove, a typical embodiment being attached securely on or inside the body, setting forth an equivalence class between torture and removal of the means for documenting torture, even within a holding compound or torture facility at a police station or obscure hideout (depending on the wearer's choice, either the apparatus only, or the combination of apparatus and wearer, would self-destruct on forced clothing removal);

The witnessential node must have the possibility to transmit live video, not just video that is recorded locally, whether the clothing is forcibly removed, or the wearer is murdered and the body is disposed of (e.g. transmission of video despite destruction of local memory of it);

The witnessential node should have the capability for self-demotion in order to have an articulable basis upon which to discount his or her own freewill or personal interest in Human Rights, a corporate hierarchy being a preferred method of attaining self-demotion, the preferred witnessential element being duty (e.g. “leave me alone, I'm just doing my job as a reporter”) to conceal or negate any perceived passion or dedication to Human Rights;

The Witnessential Network must be robust, and must not depend on any covernment (government+corporate) infrastructure (infrastructure that can be shut down by a government or corporation), although certainly some of the equipment can be donated by governments and corporations to the extent that we can verify it does not contain any hidden trojan horse-like “features”;

The witnessential node must implement the Fear of Functionality (FoF) model (as will be described, in reference to FIG. 4 and FIG. 5).

Indeed, a lack of received picture signal could indicate non-observance of agreed-upon monitoring, and should therefore be considered at least equal to a violation of human rights. (Perhaps this concept should get written into the standard declaration of human rights, http://www.un.org/Overview/rights.html.)

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1A illustrates an uncertainty based personal safety net, in which uncertainty and unsureness actually creates safety.

FIG. 1B shows a shirt-based embodiment of the conspicuously concealed imaging possibility aspect of the invention.

FIG. 2 shows an infrastructre free safety network.

FIG. 3A shows an informatic safety seed disseminator to possibly spread the seeds of visual evidence, or the potential thereof.

FIG. 3B shows an embodiment in a sports bra or the like.

FIG. 4 shows worst case network and system design.

FIG. 5 shows best case network and system design.

FIG. 6 shows a backward looking Personal Safety Device (P.S.D.).

FIG. 6A shows a PSD backpack fully equipped with radar, video camera, processor, and signage.

FIG. 6B shows a PSD backpack equipped with radar, processor, and signage, and a conspicuous camera possibility, but no actual video camera.

FIG. 6C shows a PSD backpack equipped with processor, and signage, and a conspicuous camera possibility, but no actual video camera.

FIG. 6D shows some chirplet transforms from the radar data of a backward looking radar based PSD.

FIG. 7A shows a user of a wearable PSD.

FIG. 7B shows the manner in which the wearable PSD might be removed.

FIG. 7C shows the manner in which the wearable PSD continues to provide protection even when not being worn.

FIG. 7C shows a telelight extender for extending light from a camera with built in flash so that it can be used in a wearable security dome.

FIG. 8 shows a personal safety device in the form of a incidentalizer with forgettable mode.

FIG. 9 shows a wearable dome system for providing personal safety.

FIG. 10 shows the wearable dome system with safety seal.

FIG. 11 shows a wearable theatrical piece for satire of bureaucracy and the totalitarian nature of the police state.

FIG. 12 depicts a wearable advertisting system having a wearable camera and computer system with body tracking.

FIG. 13 depicts an embodiment of the invention in which a visible deterrent exists in the form of an image of a potential assailant is projected on the floor in front of the individual's feet as the individual is walking forward.

### DETAILED DESCRIPTION OF THE PREFERRED EMBODIMENTS

While the invention shall now be described with reference to the preferred embodiments shown in the drawings, it should be understood that the description is not to limit the invention only to the particular embodiments shown but rather to cover all alterations, modifications and equivalent arrangements possible within the scope of the appended claims.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations. Similarly references to “identifier” shall include devices such as face recognizer camera vision systems, fingerprint scanners, and the like, as well as devices that capture a sample of data for later identification, such as devices that collect a DNA sample.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

References to “obfuscator”, “obfuscation increaser”, or “obfuscation articulator” shall refer to devices, processors, processes, methods, or the like, that make the locus of control of the apparatus of the invention less visible or less discernible to persons other than the user(s) of the apparatus and method of the invention. For example, a container for personal effects may have a forgettable mode in which the user can credibly forget, or allege to have forgotten, how to open the container. This forgettable mode may be made less discernible by way of complicated or seemingly complicated protocols that are either beyond the control of the user(s), or for which the user(s) can credibly allege are beyond his, her, or their control. A deniable mode of operation may also exist, in which the user(s) can deny or be credibly unsure of cause and effect relationships with regards to compliance with orders, demands, or the like placed with physical force, threat, coersion, detainment, or the like. A “deniability articulator” is that which makes deniability, or alleged deniability articulable by the user, to those requiring, demanding, or suggesting certain actions be taken or not taken by the user. Deniable modes can thus also be made less visible or less discernible to persons other than the user(s) of the apparatus, by way of obfuscators. An “obfuscation articulator” refers in particular to that which makes such obfuscation more articulable. For example, a remote escrow service may provide an articulable basis upon which to deny knowing or remembering a decryption key or password, and thus not be held in contemt of court for failing to disclose same.

References to user shall include a group of users, associates, or the like, such as a husband and wife traveling together, carrying luggage equipped with the apparatus of the invention, so that both may create, have created, allege to have created, situations that are jointly beyond their control, in being considered as a “user” of the apparatus or method of the invention. References to “user” may include a collective of users, a community of users, or the extended space of one or more users in collaboration, possibly with remote entities partially or wholly beyond user control.

References to “liabilizer”, to “liability increaser”, or to “liability articulator” shall include apparatus, devices, processors, processes, methods, or the like, that make those requiring certain behaviour of a user to assume some additional or increased liability that may arise from the user carrying out their request, order, requirement, or preference. For example, clothing or other personal effects may be equipped with medical monitoring equipment, so that its removal could either adversely affect the medical monitoring, or be alleged to adversely affect another processes, whether real, imagined, or alleged by the user. Thus, for example, a person or persons requiring or requesting the removal of the clothing or other personal effects could be held, or be alleged (by the user of the apparatus or method of the invention) to be accountable or liable for a disruption in the measurement space of a medical monitoring system, and therefore liable, for example, for possible undetected heart problems that were undetected (and thus untreated) because of a disruption in the measurement space. A “liabilizer” may, for example, be an apparatus, system, or the like, that may have been installed, or may by credibly alleged (by the user) to have been installed in a manner that would be difficult to re-install (e.g. clothing that the user can allege to be unable to reposition correctly for correct medical monitoring, or the like). A “liabilizer” may, for example, include forms to be completed or signed by a person requesting, demanding, or suggesting certain behaviour of the user, where certain legal liability is assumed. A “liabilizer” may also include video capture by the user of a request, demand, or suggestion, made to the user. A “liabilizer” can also include a requirement of certain operating parameters, such as the continued operation of a pacemaker and an associated wearable computer transmitting and receiving signals to it, or of a personal safety device with radio connection that must be maintained in order to reduce danger, or increase safety. Therefore, for example, a person requesting, demanding, or suggesting that the user ride in an elevator could be held to an increased liability for loss of communications signal, and may therefore be collegially required by the user to provide access to a stairway, even though the user of the method or apparatus of the invention would not otherwise have any power of influence over a forceful, or authoritarian official or organization. A “liabilizer” may also include a recognizer, the recognizer being a means of collecting identifying characteristics of a person presenting a demand, threat, request, or the like, to the user of the apparatus or method.

References to “incidentalizer”, to “incidentalism increaser”, or to “incidentality generator” refer to devices, processors, processes, methods, or the like, that assist the user of the method or apparatus of the invention in capturing images, or appearing to embody a possibility of capturing images merely by chance or without intention or calculation.

References to “freetime corporatizer” shall include apparatus, devices, processors, processes, methods, or the like, that assist the user of the method or apparatus of the invention to present an articulable basis upon which to be bound, in regard to the user's free time, by corporate policy or similar externalities beyond, or credibly articulably beyond, the user's control. A freetime corporatizer, for example, may be an object, obligation, task, errand, duty, or ware, assigned to an individual in order to convert his or her freetime into Corporatized time. Corporatized time is time that belongs, at least partially, to a Corporation or other externality beyond, or credibly articulably beyond, the user's control. For example, in one embodiment of a freetime corporatizer, the user may be given a small token package to carry, a token errand to run, confidential information, confidential documents, allegedly confidential information, or allegedly confidential documents, or the like, and may therefore accept these materials in order to be bound to a freedom of external locus of control. For example, prior to travel, a user can request, from a corporatized time service provider, a small package to carry and thus implicitly request to be bound to protect it. Thus the user could assert in indifference to being refused travel or lodging, e.g. an indifference to the possibility that he or she might die on the streets, but the user can make an articulable basis that he or she must protect company property, and therefore liabilize (hold more liable) a hotel owner or airline for my failure to board or provide lodging, to the user, or the like. Alternatively, a user may request a secret or allegedly confidential document, and thus, implicitly or explicitly request to be bound to protect it. An investigative photojournalist might, for example, request confidential documents and request to be required (by the provider of the means and apparatus of the invention) to photograph any situation that might constitute evidence of theft of the intellectual property contained therein. Thus, for example, the user can request to be hired (possibly for a small negligible token fee) to run an errand during the user's free time, and thus be bound to a Corporate Policy of the user's implicit choice. As another example, the user may apply for any of a variety of special corporate credit cards that each require the user to follow certain requirements, such as a special credit card that requires (by way of its cardholder agreement) that the user photograph anyone who comes in contact with this company credit card. Thus the user may, for example, select from a menu of choices of various documents or other material, each having an associated requirement. Thus the user can select from a table, or other database, which policy he or she would like to be bound by, and then find a small job or errand that requires the user be bound by the policy that the user wishes to be bound by.

A user of the means or apparatus of the invention is said to be “bound to freedom” when the user is required to carry out the user's own desire or preferences, which might, for example, include being bound by a submissivity symmetrizer. A submissivity symmetrizer is an apparatus, device, processor, process, methods, or the like, that requires the user to impose specific requirents on those who impose requirents on the user. For example, a submissivity symmetrizer may be an apparatus, device, processor, process, methods, or the like, that requires the user to obtain valid identification from an official who asks the user for identification. The user may be bound to the freedom of this symmetry, by way of being legally bound to freedom, or being actually physically bound to freedom (e.g. being unable to show identification by way of a wallet container that the user cannot open without receiving identification from the person asking to open it). A user may be legally bound to freedom, or allegedly bound to freedom (as when for example the user could open the wallet but pretends to be unable to do so until an official asking it be opened slide identification through a card reading slot on the wallet). A user may also be physically bound to freedom, for example, by way of an electrical corrective signal that causes the user to experience pain when confined away from connectivity (e.g. electrical corrective signal applied in response to data packet loss). Alternatively, a user may be informatically bound to freedom by way of a denializer, liabilizer, or the like. A means, apparatus, device, processor, process, method, or the like, which causes a user to be “bound to freedom” will be referred to as a “freedom binder”.

A user of the means or apparatus of the invention is said to be “bound to safety” when the user is required to wear or carry a device that has a potential to capture images, or a potential to contain a device that has the potential to capture images, possibly with a potential to transmit, or a potential to contain a device or process having a potential to transmit image content.

A corrective signal may include, as one possible example, an electrical corrective signal, such as an electric shock administered to the user of a personal safety device, in at least one mode of operation. The corrective signal may be articulable, in the sense of it being difficult for others to ascertain whether or not the apparatus is actually operating in that one mode of operation. Alternatively, an articulably corrective signal can comprise a mode of operation in which the severity or actuality of the corrective signal, is difficult for others to ascertain, wherein therefore others can be held, or imagined to be held, liable for the corrective signal, whether actual, percieved, or imagined by a user of the personal safety device. To make this corrective signal more articulable, it may be synchronized with an externally percievable stimulus that can be observed by others, such as actual muscle contraction of the user, or a loud snapping noise of an electrical spark, or the like, where the actual severity of the electrical signal may be drastically reduced from the severity apparent to persons other than the user.

When it is said that a person can validly open a lock, this means that the lock can be opened without excessive force, circumvention, or traverse of its intended manner of being opened.

A communications distance is a distance as measured by reception of a communications medium such as a string, cord, or wire that may become severed or unplugged in excess of the communications distance, or a radio signal that may fall below a certain threshold or for a certain time when the device is taken beyond the communications distance.

When it is said that object “A” is “borne” by object “B”, this shall include the possibilities that A is attached to B, that A is bonded onto the surface of B, that A is imbedded inside B, that A is part of B, that A is built into B, or that A is B. An example of “A is B” might be a camera-bearing pair of eyeglasses, in which the eyeglasses themselves are a camera, in the sense that there is a CCD sensor array somewhere in the eyeglasses, a lens somewhere in the eyeglasses, and a cavity between the two that is part of the eyeglasses, and has no clearly separable portion that could be regarded as a separate entity.

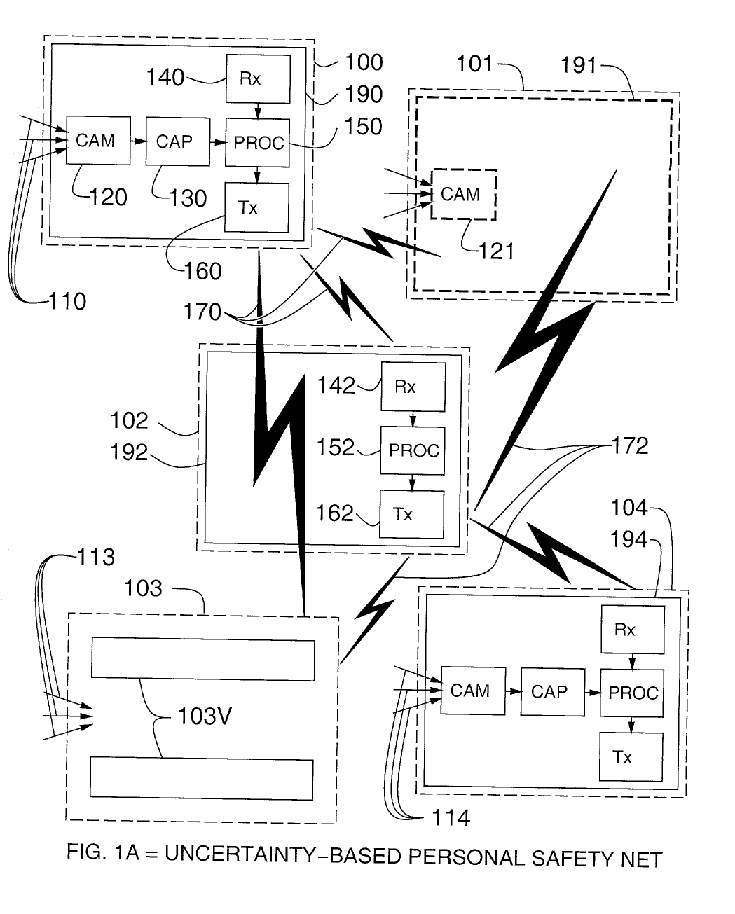

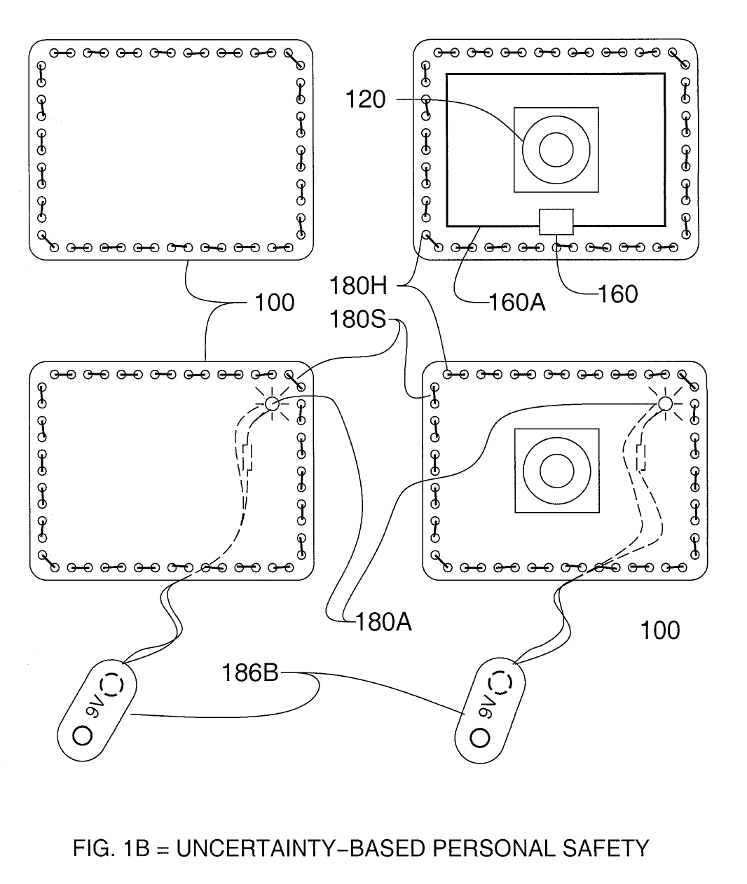

FIG. 1A is a diagram depicting a Witnessential Network (TM) based on the principle of uncertainty and the principle of conspicuous concealment of imaging possibilities.

The Witnessential Network comprises a number of possibly decorative outer optical housings 100, 101, 102, 103, and 104. Preferably optical housings 100, 101, 102, 103, and 104 are made of a smooth shiny material such as smoked acrylic, smoked polycarbonate, or the like. Preferably outer optical housings 100, 101, 102, 103, and 104 have a concomitant cover purpose such as being name badges for a uniform, or templates bearing corporate insignia, or the like. Alternatively, optical housings 100, 101, 102, 103, and 104 may be decorative in nature, and thus serve as jewelery, fashion accessories or parts thereof, or be incorporated fashionably into garments.

In one embodiment, optical housings 100, 101, 102, 103, and 104 are hemispherical domes having an appearance of wine-dark opacity, yet being transparent to optical instruments contained therein. Smoked acrylic or smoked polycarbonate domes will provide suitable optical housings 100, 101, 102, 103, and 104. Modern cameras are very small, and typically pinhole cameras have an opening of only 1/32 of an inch (e.g. an opening less than one millimeter in diameter). Thus optical housings 100, 101, 102, 103, and 104 could, in principle, be only a few millimeters in diamter, with the bulk of the camera being inside the accessory, garment, or the like.

However, in a preferred embodiment of the invention, optical housings 100, 101, 102, 103, and 104 preferably have an ornamental aspect that serves as a deterrent to crime, even if this deterrent is only mild (sometimes even subconscious). Experiments have found that there is less crime in the presence of smoked acrylic, smoked lexan, or the like, whether or not persons are aware of the meaning therein (e.g. the imaging possibilitly that it affords).

This finding suggests that decorative optical elements comprising conspicuously concealed or at least slightly conspicuous imaging possibilities can be made to be useful in reducing crime, human rights violations, or the like.

Light rays 110 enter optical housing 100 and are absorbed and quantified by camera 120, which provides an output to capture device 130. Processor 150 receives an input from capture device 130. Transmitter 160 occasionally sends a picture captured by capture device 130. In a preferred embodiment of the invention, transmitter 160 occasionally sends a picture for possibly being received by other nodes in a Witnessential Network. Receiver 140 may also receive data from other nodes of the Witnessential Network. For example, receiver 140 may receive pictures transmitted from other nodes.

FIG. 1a depicts five maybenodes of a Witnessential Network. Maybenodes are optical housings that may or may not contain cameras, or that may contain additional optics having the visual appearance of cameras wherein the nodes may or may not be active. This uncertainty is an important element of the Witnessential Network.

For example, optical housing 101 contains a maybecamera 121. The maybecamera is denoted by a dotted line, and may be simply a dummy lens behind the smoked acrylic optical housing 101.

Different versions may be worn by different people in the Witnessential Network, e.g. some of the wearers may wear fully equipped nodes while others may choose to wear dummy systems having various lesser degrees of funcionality ranging from nothing but a piece of smoked acrylic, all the way up to partially but not wholly working systems. Some of these dummy systems such as that depicted behind optical housing 102, contain an active packet forwarding system comprised of receiver 142, processor 152, and transmitter 162 built into internal housing 192. Thus some of the dummy systems may serve as working repeaters to be active nodes in the Witnessential Network, but not capable of taking pictures. Thus these active dummy systems merely serve to forward packets 170 of picture information to and from actual working systems in the network, such as between internal housing 190 and internal housing 194. In this situation, we assume that internal housing 190 and internal housing 194 are too far apart, or not in line of sight, so that they cannot so easily communicate directly with one another.

Ideally the communication is viral, so that rays of light 110 entering camera 120 form an image that is sent to and stored in internal housing 194 by way of the intermediate packet forwarding station in internal housing 192. This communication is ideally viral in the sense that transmitter 160 tries to broadcast packets 170 with the hope that some receiver somewhere might pick up some of these packets. Thus the packets eventually find themselves stored as image data in internal housing 192 as well as internal housing 194. Likewise the images in internal housings 192 and 194 will be broadcast to other receivers that might happen to be in the area.

Since internal housing 194 also contains pictures from light rays 114 as well as pictures received from other internal housings, these pictures will also hopefully eventually propagate back to internal housing 190. It is not necessary to guarantee that this propagation takes place, but merely to make it difficult for a war criminal to guarantee that it does not take place.

In FIG. 1a four of the five optical housings are depicted with mechanical internal housings 190, 191, 192, and 194 inside (or behind) the optical housings.

These mechanical internal housings 190, 191, 192, and 194 may be removably attached, so that users can exchange them, or mix and match, sometimes wearing an internal housing and sometimes not.

Thus advantageously optical housings such as optical housing 103 may have attachers, such as Velcro (TM) strips 103V for easy removal.

Such easy removal serves two purposes: (1) to keep the war criminals unsure by constantly mixing up possibilities; and (2) in the case of garments, making it easy to wash the garment by easy removal of the internal housing. Alternatively the mechanical internal housings may be made waterproof, and also suitable for running through rain or being exposed to spray by adversaries who might try to switch on water (irrigation systems or spray park) into a park or place of protest.

FIG. 1B shows an uncertainty based personal safety system in which optical housings 100 are comprised of smoked acrylic sheets with holes 180H drilled around the outside, for being sewn onto T-shirts or the like, by way of stitches 180S.

Camera 120 is removably attached to the back of the smoked acrylic along with a transmitter 160. A loop antenna 160A is permanently attached to the back of, or embedded within, the acrylic. Alternatively the entire device may be vitrionic. Vitrionic systems comprise electronic devices embedded in glass or transparent plastics.

A battery holder 186B exists even on some units not having a camera. The battery holder may be a 9 volt battery snap, connected trough an appropriate circuit (series resistor or the like) to an annunciator 180A. A satisfactory annunciator is a red LED, possibly a flashing red LED. Alternatively a three digit seven segment LED displaying “rEC” (indicating “RECord”) may serve as a useful annunciator. The annunciator can be present with the camera, without the camera, or on a floating basis where there is sometimes a camera present.

Versions of the apparatus can be shared and swapped among participants so that they can deny knowing whether or not a camera is present.

Alternatively a denializer can be used, such as a method of doing business in renting the devices so that those renting the devices need not know whether or not the devices are recording or even have cameras.

Another good denializer is a company uniform, or even something that looks like a uniform. Since it is now fashionable to wear uniforms for fashion in everyday life (e.g. people often wear hosptital scrubs or military fatigues to dance clubs or in other leisure actvities) the device can be incorporated into a uniform, and the uniform forms the denializer. Thus the wearer can say “I don't know if it's a camera, I'm just doing my job” or “It's standard issue [uniform] I don't know how it works.”. With a mail delivery clerk's uniform the wearer might say “don't shoot the messenger”.

Such subservience empowerment serves to create a balance of bureaucracy, allowing the invdividual to self-bureaucratize.

A typical example of such a situation is when a person tries to negotiate with a used car salesman, and the used car salesman might say something like “I'd love to give you the car for $1000; let me check with my manager”. The used car salesman then disappears into a back room, has a coffee, and reads a newspaper for a few minutes, and then comes out and says “I'd love to give you the car for $1000 by my manager won't let me.”. Although the salesman never talked to a manager, the salesman has some degree of power over the customer by virtue of being able to credibly pretend that he is bound by a higher authority. A credible, articulable, higher and unquestionable authority allows representatives of organizations to obtain external blame and excuses for their otherwise irrational or disagreeable actions.

Unfortunately the individual person does not ordinarily enjoy the same luxury as the clerk, and must therefore behave more rationally, or risk seeming irrational, rude, or otherwise inappropriate. For example, if an individual carried a handheld video camera around videotaping clerks, casino operators, police officers, customs officials, and the like, the individual might be regarded as strange, rude, or otherwise acting in an inappropriate manner.

The individual could rely on religion, as a manager, by, for example, wearing a camera contraption as part of a religious order. Just as religion allows individuals to wrap their heads in various materials that would otherwise be regarded as inappropriate, a new religion such as the “personal safety religion” could be invented, that required its members to wear cameras.

Thus religion could form a similar purpose to the manager for the individual, but there is the danger that others (including clerks) may dismiss the individual as a religious freak. Therefore, what is needed is a similar way for the invididual to have excuses for and to externalize blame for otherwise irrational or disagreeable actions.

An important aspect of the invention is for the individual to be able to nonconfrontationally inflict fear of accountability, uncertainty, or doubt on persons exerting physical or other coercive force, or the threat or possibility thereof, upon the user of the invention. This can be done by way of an incidentalist imaging possibility.

Incidentalist imaging refers to imaging which can be made to seem as if it occurs merely by chance or without intention or calculation. An incidentalist imaging system may in fact blatantly capture images (as by an articulable requirement from a higher authority to do so), or it may present itself as a device that could capture images in a way in which it is difficult to discern the intentionality of the use of the invention.

Thus embodiments of the invention may allow an individual to have a credible mechanism to externalize at least a portion of his or her image capture actions to a Safety Management Organization (SMO). The SMO provides an articulable basis upon which to deny free will or self determination. The SMO creates a management system, either real or percieved by others.

Then the individual can indicate that the directive for use of a Personal Safety Device (PSD) comes from head office and defer queries to spend several hours waiting on hold and calling various telephone numbers, etc. Head office can then say that the PSD is used because the insurance company requires it.

Thus founding an insurance company requiring individuals to wear PSDs may also assist in protecting Human Rights.

Thus the life insurance company has provided the individual with a means for articulably externalizing his own irrational actions. Now the individual can say “I'm wearing this camera because my manager (SMO) requires it, and the insurance company requires the SMO to require me to wear it, etc.”.

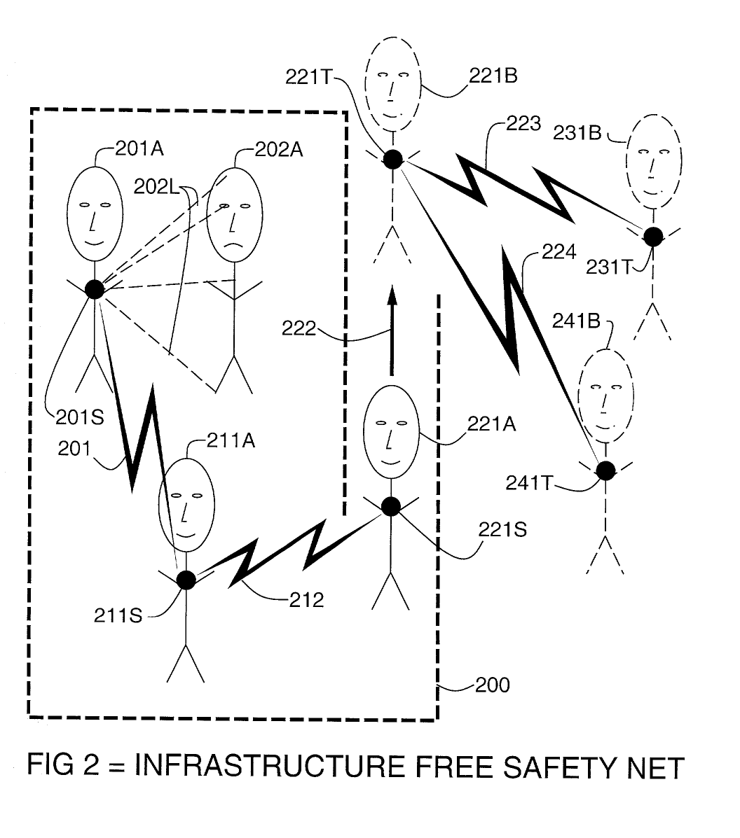

FIG. 2 depicts an infrastructure free safety net. An individual 201A wears a safetycharm 201S. The safetycharm is preferably decorative in nature, such that it appears like a jewel, tie clip for a necktie, neclace, or other accessory having a decorative or articulably ornamental, religious, or sentimental significance, or the appearance thereof. The safetycharm may either have a covert camera concealable within it, so that it does not appear as if it could house a camera, or it may actually be made to appear to have the possibility of housing a camera. The former embodiment (safetycharm not appearing as if it could house a camera) is one embodiment of the invention, but the preferred embodiment is the latter embodiment (safetycharm appearing to have the possibility of housing a camera). Preferably the safetycharm has an optical appearance, such as a smoky vitreous, glazed, or mirrorlike finish similar to smoked acrylic ceiling domes in which cameras are often placed. Although not everyone would recognize such a safetycharm as having cameralike qualities, the more paranoid fraction of the population may at least be concerned. For example, it is found that casino operators, customs officials, and corrupt politicians, are among the more paranoid, and often are at least unsure whether or not typical embodiments of the safetycharm 201S are cameras. The safetycharm 201S is preferably very subtle in the conspicuously concealed imaging possibility provided therein, but nevertheless presenting itself at least to such a degree of such a possibility that at least some of the most paranoid of criminals would be a little uneasy in the presence of such a possibility. Preferably the safetycharm 201S has a natural enough appearance as to make such a device appear fashionable, so that any concerns directed at it will seem paranoid.

Alternatively, the safetycharm may comprise an actual lens, mounted in a decorative housing, or in a garment, so that there may or may not be a camera behind the lens. A mounting attachment lets the dummy units be rapidly and easily exchanged for live systems. Preferably the dummy systems and the live systems are interchangeable, so that an official such as assailant 202A can never be certain whether or not a particular individual 201A is packing a camera even if the official such as assailant 202A knew whether or not the individual previously was packing a camera.

Preferably a method of doing business is provided in which user 201A can purchase a safetycharm without having to know whether or not it contains a camera. Preferably, for example, the information about whether or not a camera is present is contained in a sealed envelope which the buyer need not open if he or she would not like to know whether or not the safetycharm contains a camera. Thus when individual 201A is asked by official such as assailant 202A whether or not the safetycharm is a camera, individual 201A can reply: “I do not know sir; it could be.”.

In another embodiment of the method of doing business in personal safety, the safetycharms are rented or swapped with a safety service provider, and the safety service provider swaps around cameras and dummy units, and services the units, so that subscribers to the safety service merely pick up a safetycharm, which, for example, has a lens with a decorative housing so that individual 201A need not have knowledge as to whether or not a camerea is actually present.

Preferably the method of doing business in personal safety services provides the individual 201A with a method of directing official such as assailant 202A to a higher authority for additional information and questions. This method could comprise simply handing official 202A a brochure that came with the safetycharm 201S in which the brochure describes the safetycharm as possibly containing a camera with no way to determine whether or not it does, or in which the brochure describes the safetycharm as being a device that has magical properties of warding off evil spirits when it is connected to a 9 volt battery.

Preferably the safetycharm has a secondary or concomitant need or rationale for being supplied with electricity. For example, the safetycharm 201S may include a decorative electrical display, such as a nice pattern of lights, which warrants connection to electricity. In this way, the owner or user such as individual 201A is provided with a concomitant articulable basis upon which to provide the device with electricity.

In another embodiment, the user is provided with a brochure alleging that the safetycharm 201S brings good luck when connected to electricity. Thus the user can articulably allege that he or she is simply wearing an electrically powered good luck charm, and provide official such as assailant 202A with a brochure that describes the device as an electrically powered good luck charm. The safetycharm can be described in either the positive (e.g. that it provides good luck when connected to electricity) or in the negative (e.g. that it deters or drives away bad luck when connected to electricity). The latter (that it deters bad when connected to electricity) is more correct, literally, with the notion that criminals would be afraid of the accountability that safetycharm 201S could provide if it were a camera, and therefore such criminals would be less likely to comit a crime against individual 201A.

Preferably safetycharm 201S has some kind of indicator, such as a blinking red LED, or the like, to indicate that electricity is connected to it, and that it is therefore driving away evil sprits, bad luck, and criminal activity.

Preferably a number of safetycharms such as safetycharm 201S are manufactured, some containing cameras and others not containing cameras, but all or most of them having means for being supplied with electricity even when they do not contain a camera.

On the assumed possibility that safetycharm 201S actually contains a camera, it preferably also contains a means for sending at least some pictures elsewhere, so that if siezed by official such as assailant 202A the images cannot be deleted. Preferably the safetycharm 201S is of very low cost, and of great ubiquity, so that many persons could afford to buy it and wear it.

In one method of doing business, persons could be awarded points for wearing their safetycharms, so that when asked by officials such as official such as assailant 202A why the safetycharm is being worn, individuals such as individual 201A can reply that he or she is wearing it to earn points, according to a certain policy of an external entity (such as a safetycharms corporation).

These methods of externalizing the knowledge of operation or the rationale for wearing the safetycharm 201A consist of a proceduralizer, where the proceduralizer involves shrouding the knowledge or rationale in formalized procedure, or articulable alleged formalized procedure.

Therefore individual 201A is wearing safetycharm 201S and official such as assailant 202A does not have an articulable basis upon which to require individual 201A not to wear the safetycharm. Additionally, the safetycharm can include a liabilizer in which compliance with a request by official such as assailant 202A for removal of the safetycharm includes some personal liability.

Examples of liabilizers include an additional medical monitoring function, such as a heart monitor, or even just a reduced insurance rate for wearing the safetycharm (e.g. an externalized or prodeduralized requirement that individual 201A can cite for needing to wear safetycharm 201S for medical purposes, insurance purposes, or the like).

Once worn, if in fact it contains a camera, it also preferably contains a low power transmitter for conveying images over a short distance, such as by signal 201, to another person who is wearing a safetycharm 211S. Since there is a nonzero possibility that both safetycharms 201S and 211S are real functioning devices with real functioning cameras, there is the possibility that pictures of official such as assailant 202A will spread throughout a room 200 where multiple persons are either detained, waiting, or the like. Any one person such as individual 211A who leaves the room carries with him or her the possibility, for example by way of signal 212, that his or her safetycharm 221S will carry away image content from the room 200. Thus even if the room 200 is shielded against transmission or reception of data, official such as assailant 202A cannot be certain of the absense of evidence of misconduct as soon as any one person has left the room 200, even if the person who left did not witness any such misconduct.

This model is very much like an evidence contagion in which one individual witnessing a truth can “infect” other individuals with a truth “virus”, being simply the possibility of evidence escape.

Furthermore when an individual such as individual 221A leaves the room and moves out position of the same individual 221B, he or she carries with him or her the safetycharm into a new position denoted as safetycharm 221T. Individual 221A is the same as individual 221B but at a different time, e.g. A denoting a first time and B denoting a later time. Likewise safetycharm 221S is the same as safetycharm 221T but at a later time, T denoting a later time than S. The process of egress is denoted as egress path 222.

Now once individual 221A becomes individual 221B (e.g. outside room 200), then the individual 221B spreads the seeds of evidence possibility to individual 231B by way of signal 223 and to individual 241B by way of signal 224. Thus safetycharms 211S, 221S, 231T, and 241T are all “infected” with a possibility that they might contain data pertaining to a picture or pictures of official such as assailant 202A or related evidence of misconduct of official such as assailant 202A.

In the preferred embodiment of the invention the communication is by way of optical line of sight data communications, with simple infrared LEDs. In this way the cost of the safetycharms is very low.

The invention can make use of an infrastructure such as a cellular telephone network, but in the preferred embodiment the invention forms a safety network that is infrastructure free. In particular, the preference for an infrastructure free safety network arises from the fact that there have been instances when officials shut down cellphone connections of civilians when engaged in misconduct. Thus the network preferably cannot be shut down by any one official or group of officials.

An uncertainty service can be provided, for example, by way of equipment rental. loan, shuffling, or other obfuscation, in which the wearer can be provided with a denializer, such as an articulable basis upon which to deny knowledge of whether or not a camera is present in the apparatus. Even if the inventor (e.g. the applicant of this patent) and his friends or family were wearing these devices, e.g. even if the devices were designed and built by the wearer he could still truthfully say: “Even though I made these myself, I don't know which ones are transmitting live video to the Internet, because My Manager shuffled them before we put them on.” Thus a denializer service may simply comprise a shuffling of shirts or other clothing and accessories that may or may not contain cameras.

Providing uniforms can also serve as a denializer. Alternatively, clothing rental services can be provided where there is an option in which the renter can specify that he or she would not like to know whether or not a camera is present. Moreover, renters can specify a percentage probability that they would like to be used in determining whether or not a camera is present. For example, a person can rent a piece of jewelry or clothing or the like and request that there be a 95% chance that it have a camera and transmitter. A special promotional advertisement can feature dodecahedron shaped dice being rolled to decide whether or not cameras are issued to wearers.

With the conspicuously concealed camera possibility of the invention, uniforms can be shuffled and issued to wearers to empower the wearers with the denializer of uncertainty afforded therein.

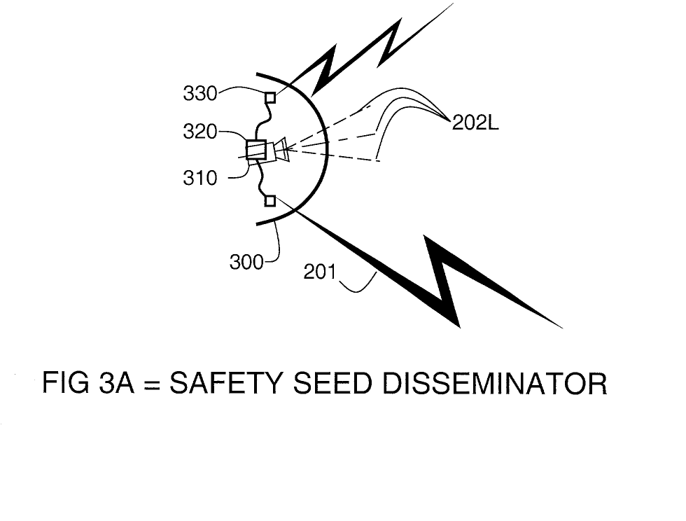

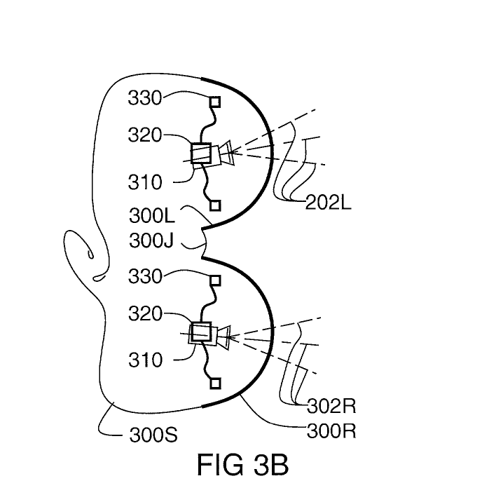

FIG. 3A shows an embodiment of the safety network using a wearable dome shaped safetycharm. A dome 300 is provided for concealing either of the following:

a camera;

the absense of a camera.

Concealment of the absence of a camera comprises concealing the fact that no camera is present, so that a would-be perpetrator cannot be certain that no camera is present in the safetycharm.

Preferably the dome 300 is either a smoked acrylic or plexiglass dome of wine dark opacity, or has a partially transparent mirrorlike finish to make it hard for a would be perpetrator to see inside it. A shroud inside can further obfuscate whether or not a camera is present. Thus the material of dome 300 is preferably such that rays of light 202L can enter, with their fate being uncertain.

A cameara 310, if present, is fixed to a mount 320 and connected to one or more transmitters 330, or to storage capabilities.

In marketing the safetycharm, an analogy can be made to good luck charms such as 4 leaf clovers, that chase away evil spirits. A service can be provided to rent these good luck charms to users, in which the users can choose not to know whether or not a camera is present in the device. This gives the wearer an articulable denializer for the camera, along with a means for diversion from questioning by others, in the sense that the user can say: “I'm not sure what it is, but it's supposed to chase away evil spirits when supplied with a 9 volt battery.”.

FIG. 3B shows an embodiment of a personal safety device using two wearable dome shaped conspicuously covert imaging possibilities connected to each other. Domes 300L and 300R are preferably made of smoked acrylic, smoked polycarbonate, or a mirrored partially transparent material. They can be connected together by virtue of being sewn to a garment such as a tank top or the like, or they can be connected together separately by a joiner 300J and worn with a strap 300S.

This embodiment of the invention is made for being worn like a sports bra, or tank top (preferably a black tank top to return approximately ε² of the preferably small transmission coefficient ε of the transparent dome material). The two domes 300L and 300R are made for being worn as the cups of the top (the top comprising a tank top, sports bra, or just the dome cups themselves).

A left cup dome 300L is provided for concealing either of the following:

a camera;

the absense of a camera.

Concealment of the absence of a camera comprises concealing the fact that no camera is present, so that a would-be perpetrator cannot be certain that no camera is present. The fate of rays of light 202L entering the left cup are thus not known to potential assailants, and, with a denializer, can also remain unknown to the wearer.

A right cup dome 300R is provided for concealing either of the following:

a camera;

the absense of a camera.

Concealment of the absence of a camera comprises concealing the fact that no camera is present, so that a would-be perpetrator cannot be certain that no camera is present. The fate of rays of light 302R entering the right cup are thus not known to potential assailants, and, with a denializer, can also remain unknown to the wearer.

In some embodiments, a heart monitor is included. If a heart monitor is included, it is preferably in the left cup to trigger image capture, taking more pictures when the heart beats faster. The personal safety top of this invention can be used for a reversalism of “male gaze” by allowing a female wearer of the apparatus to capture images of men who might otherwise be violating her privacy or solitude by looking at her, or making rude comments. With a microphone in the top, as well as one or more cameras, she can capture evidence of verbal an physical abuse, as well as evidence of harrassment.

With a denializer, she can also be unsure as to whether or not the top contains any cameras. With the heart monitor of the invention, another form of denializer is possible in which the apparatus of the invention uses heartrate as a natural index into framerate (e.g. so framerate is proportional to her degree of arousal). Thus image capture is involuntarily controlled by the wearer (e.g. heart rate being an externality not directly under her intentioned control). In this way the apparatus provides an incidentalist element. Taking pictures thus becomes an incidental side effect of something else. This incidentalizer of the invention will be useful for protecting the wearer from harrassment directed at the mere fact that the wearer is wearing a personal safety device. Moreover, if an assailant were to object to the camera, or the possibility of a camera, by assailing the wearer, whether verbally objecting to the camera, or otherwise, the frame rate would increase.

Thus a potential perpetrator who became upset at the wearer for photographing him, would cause her heart to beat faster which would cause her to take more pictures of him.

This results in a reflectionist imaging device, in which the subject of the pictures (namely the assailant) is the one who, through his actions, causes pictures of himself to be taken.

Since this feedback loop is beyond the control of the wearer of the personal safety device, there is an articulable basis upon which the wearer can argue that the assailant was taking pictures of himself by agitating her. Thus a new and useful embodiment of the denializer and incidentalizer has been invented.

The use of a sports bra forces would-be human rights violators or perpetrators of violence to make a choice between accepting the possibility of accountability, or making an exceedingly unreasonable request such as asking the victim to remove the sports bra, which would make a would-be human rights violator seem unreasonable and overly paranoid.

This embodiment also has artistic value in the tradition of cultural criticism, in the Reflectionist tradition of turning the tables on the “male gaze” by allowing a female wearer of the apparatus to capture images. This value as an artistic statement may also serve to externalize the locus of responsibility in the sense that the wearer can indicate that she is a performance artist, and that the system is a legitimate artistic statement.

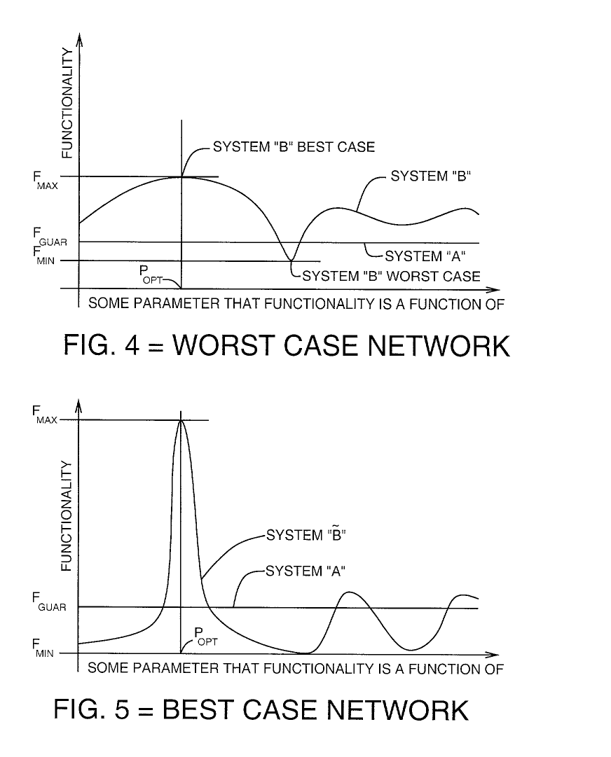

FIG. 4 depicts a worst case network design.

In the Picture Transfer Protocol (PTP) of the invention it is desired that a single packet be a single picture, such that a single packet from a packet sequence has a high degree of relevance and meaning even when it is taken in isolation (for example when the packets before and after it have been corrupted). Moreover, the system is preferably made serendipitous, even if doing so makes the system highly unreliable. Thus to the extent that pictures can only be transmitted occasionally, but really well unpredictably, therefore, the system induces upon perpetrators a Fear of Functionality (FoF) model.

The mathematical and implementational details of FoF and PTP are disclosed in “Comparametric Transforms for Transmitting Eye Tap video with Picture Transfer Protocol (PTP)”, written by the inventor, S. Mann. This work appears as chapter 4 of “Transform and Data Compression Handbook”, edited by K. R. Rao and Pat Yip, published by CRC Press, Sep. 27, 2000, ISBN: 0849336929. In this disclosure only a brief summary is provided.

Because each packet is a picture, if we randomly select a few packets from a stream of thousands of packets of PTP, we have data that provides a much more meaningful interpretation to the human observer than if all we had were randomly selected packets from an MPEG sequence.

Personal Imaging systems are characterized by a wearable incidentalist “always ready” mode of operation in which the system need not always be functioning to be of benefit. It is the potential functionality, rather than the actual functionality of such a system that makes it so different from other imaging systems like hand held cameras and the like.

The networking aspects of the invention differ from other wireless data transmission systems in the sense that the invention is preferably designed for “Best Case” operation. Ordinarily, wireless transmissions are designed for worst case scenarios, such as might guarantee a certain minimum level of performance throughout a large metropolitan area. The Personal Safety Device, however, is designed to make it hard for an adversary to guarantee total nonperformance.

It is common that state-sponsored terrorists use electronic devices to jam radiowaves allegedly to prevent independent terrorists from activating explosives by radio remote control, or the like. Another effect, whether intended or not, is to adversely affect traditional personal safety devices such as cellular telephones. Therefore, a system is needed to potentially send the radio signals for personal safety and accountability.

Rather than traditional anti-jamming and frequency hopping technologies, the Witnessential Network makes use of serendipitous communications.

It is not a goal of the Personal Safety Device to guarantee connectivity in the presence of hostile jamming of the radio spectrum, but, rather, the goal is to make it difficult for the adversary to guarantee the absence of connectivity. Therefore, an otherwise potential perpetrator of a crime would never be able to be certain that the wearer's device was non-operational and would therefore need to be on his or her best behavior at all times.

Traditional surveillance networks, based on so called “public safety” camera systems have been proposed to reduce the allegedly rising levels of crime. However, building such surveillance superhighways may do little to prevent, for example, crime by representatives of the surveillance state, or those who maintain the database of images. Human rights violations can continue, or even increase, in a police state of total state surveillance. The same can be true of owners of an establishment where surveillance systems are installed and maintained by these establishment owners. Examples such as the famous Latasha Harlins case in which a shopper, falsely accused of shoplifting by a shopkeeper, was shot dead by the shopkeeper. Therefore what is needed is a Personal Safety Device, to function as a crime deterrent, particular with regards to crimes perpetrated by those further up the organizational hierarchy.

Since there is, and would be, the possibility of just one packet, which contains just one picture, providing incriminating evidence of wrongdoing, an individual can simply wear a personal safety device to obtain protection from criminals, assailants, and attackers, notwithstanding any alleged public or corporate video surveillance system already in place.

An important aspect of this paradigm is the Fear of Functionality (FoF) model. The balance is typically tipped in favour of the state or large organization, in the sense that state owned, or corporate owned surveillance cameras are typically mounted on fixed mount points, and networked by way of high bandwidth land lines. The Personal Safety Device (PSD), on the other hand, is connected by way of wireless encrypted communication channels of limited bandwidth and limited reliability. For example, in the basement of a department store, the individual has a lesser chance of getting a good reliable data connection than the store-owned surveillance cameras. Just as many department stores use a mixture of fake nonfunctional cameras and real ones, so that the customer never knows whether or not a given camera is operational, what is needed is a similar means of best case video transmission. Not knowing whether or not one is being held accountable for one's actions, one must be on one's best behavior at all times. Thus a new philosophy, based on FoF, can become the basis of design for image compression, transmission, and representation.

With reference, once again, to FIG. 4, which shows a WORST CASE NETWORK, given two different systems, SYSTEM “A” having a guaranteed minimum level of functionality F_{GUAR} that exceeds that of SYSTEM “B”, an articulable basis for selecting SYSTEM “A” can be made. Such an articulable basis might appeal to lawyers, insurance agents, and others who are in the business of guaranteeing easily defined articulable boundaries. However, a thesis of this paper is that SYSTEM “B” might be a better choice. Moreover, given that we are designing and building a system like SYSTEM “B”, traditional Worst Case engineering would suggest focusing on the lowest point of functionality of SYSTEM “B”.

Imagine, for example, a user in the sub basement of a building, inside an elevator. Suppose SYSTEM “A” would have no hope of connecting to the outside world. SYSTEM “B”, however, through some strange quirk of luck, might actually work, but we don't know one way or the other, in advance.

The fact of the matter is, however, that one who was hoping that the system would not function, would be more afraid of SYSTEM “B”, than SYSTEM “A”, because it would take more effort to ensure that SYSTEM “B” would be nonfunctional.

The Fear of Functionality (FoF) model means that if there exists the possibility that the system might function part of the time, so that a would-be perpetrator of a crime against the wearer of the personal safety device must be on his or her best behavior at all times.

FIG. 5 shows a BEST CASE NETWORK. This figure shows the best case design model of the invention. This design effort is directed at emphasizing the highest point of functionality of SYSTEM “B”, to make it even higher, at the expense of further degrading the SYSTEM “B” WORST CASE, and even at the expense of decreasing the overall average performance. The new SYSTEM “\tilde{B}” is thus sharply serindipitous (e.g. peaked in its space of various system parameters. It is much harder for state-sponsored terrorists to guarantee that they can hide from accountability by jamming this system.

Thus FIG. 5 depicts what we can do to further improve the “fear factor” of our SYSTEM “B”, to arrive at a new SYSTEM “\tilde{B}”. The new SYSTEM “\tilde{B}” is characterized by making it even more idiosyncratic, such that the occasional time that SYSTEM “\tilde{B}” works, it works really well, but most of the time it doesn't work at all, or works very poorly.

Other technologies, such as the Internet, have been constructed to be robust enough to resist the hegemony of central authority (or an attack of war). However, an important difference here is that the FoF paradigm is not suggesting the design of robust data compression and transmission networks.

Quite the opposite is true!

The FoF paradigm suggests the opposite of robustness, in the sense that SYSTEM “\tilde{B}” is even more sensitive to mild perturbations in the parameter space about the optimal operating point, P_{OPT}, than SYSTEM “B”. In this sense, our preferred SYSTEM “\tilde{B}” is actually much less robust than SYSTEM “B”. Clearly it is not robustness, in and of itself, that is desired in the invention.

The personal safety device need not work constantly, but, rather, must simply present criminals with the possibility that it could work sometimes, or even just occasionally. This scenario forms the basis for best-case design as an alternative to the usual worst-case design paradigm.

The Personal Imaging system therefore transmits video, but the design of the system is such that it will, at the very least, occasionally transmit a meaningful still image. Likewise the philosophy for data compression and transforms needs to be completely re-thought for this FoF model.

This rethinking extends from the transforms and compression approach right down to the physical hardware. For example, in some embodiments the invention includes a jacket that contains a large low frequency antenna, providing transmission capability in a frequency band that is very hard to stop. A satisfactory frequency band is the 10 meter band because of its unpredictable performance (owing to various “skip” phenomena, etc.). Additionally, other frequencies are preferably also used in parallel.

Preferably a peer to peer form of infrared communication is also included, to “infect” other participants with the possibility of having received an image. In this way, it becomes nearly impossible for a police state to suppress the signal, because of the possibility that an image may have escaped an iron-fisted regime.

It is not necessary to have a large aggregate bandwidth to support an FoF network. In fact, quite the opposite is true.

Since it is not necessary that everyone transmit everything they see, at all times, very little bandwidth is needed. It is only necessary that anyone could transmit a picture at any time. This potential transmission (e.g. fear of transmission) need not even be to the Internet, e.g. it could simply be from one person to another to another person.

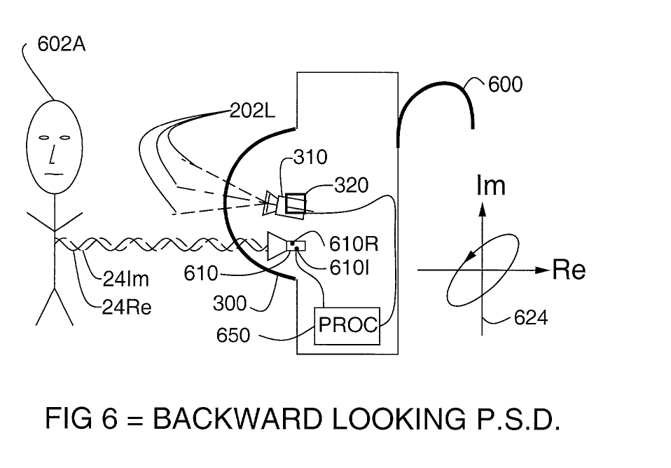

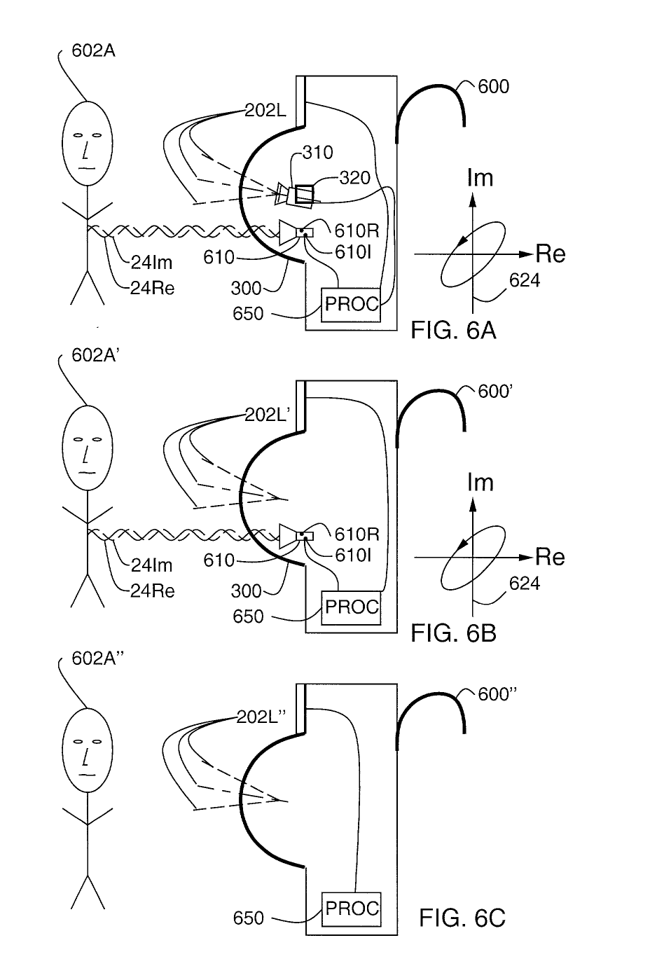

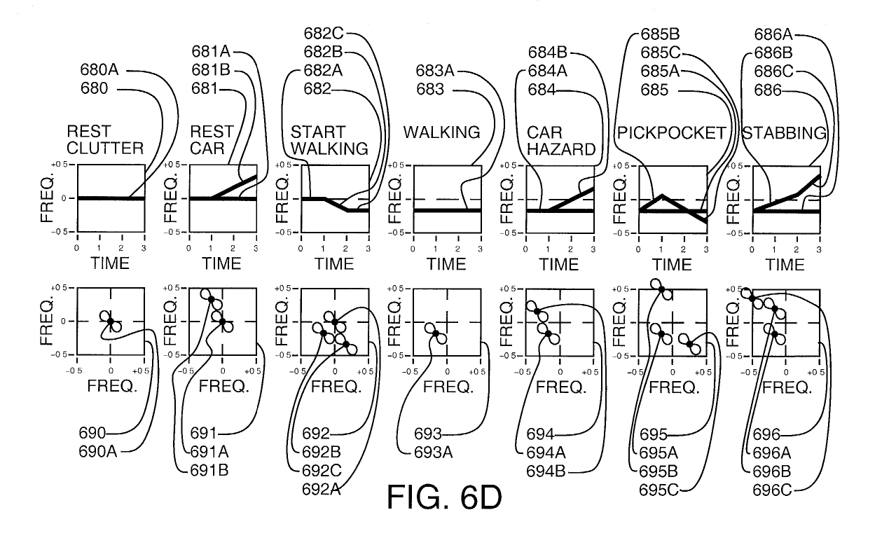

FIG. 6 shows a backwards looking Personal Safety Device (PSD). A backpack based apparatus 600 has a dome 300 sewn onto the back of the backpack for being worn by a person wishing to be safe and secure or a person wishing to make others feel comfortable knowing that they are safe and secure. The dome 300 faces backwards, so that a camera 310 inside the dome has a view of what is behind the wearer of apparatus 600.

Camera 310 provides a video signal to a processor 650. The processor controls a pan-tilt camera mount 320 to which camera 310 is fitted. Rays of light 202L can enter through the smoked acrylic or mirrored partially transparent material of dome 300 and enter camera 310.

A video motion detector senses motion of a potential assailant coming up behind the wearer of the apparatus 600. A video orbits processor, as described in the lead article entitled “Humanistic Computing” by S. Mann, in Proc. IEEE, Vol. 86, No. 11, November 1998, pages 2123-2151+cover, is first used to factor out movement of the wearer, and then residual movement of an assailant 602A can be used to trigger video capture.

Alternatively, a radar system, microwave motion detector, or gunnplexer device 610 in the backpack detects certain movement signature patterns of the assailant 602A. A real return 24Re, and imaginary return 24Im are detected by way of detector diodes 610R and 610I which are mounted preferably separated by a distance λ_{g}/2 or suitable odd multiple thereof (e.g. at an odd number of quarter wavelengths) along a waveguide in a receiver at device 610, where the wavelength, λ_{g} is the wavelength in the waveguide.

To the extent that diodes 610R and 610I are not exactly mounted an odd number of quarter wavelengths apart, an assailant coming toward the wearer traces out a counterclockwise ellipse as shown in plot 624 rather than a counterclockwise circle. Plot 624 is a plot of real and imaginary returns, on against the other, as might be formed by using an “XY” plotting oscilloscope with the real signal on the “X” axis and the imaginary signal on the “Y” axis.

FIG. 6A shows the Personal Safety Device with a display 651. A satisfactory display 651 is a flat screen video display. Display 651 connected to processor 650 may display content that is responsive to an output from camera 310.

The display 651 may effect behavioural modification of assailant 602A before a crime has been committed. Displaying an output image from camera 310, for example, will remind assailant 602A of the possibility of accountability, in much the same way that television screens are hung from the ceilings of department stores, near entrances, displaying video from nearby cameras to deter would-be criminals.

Moreover, the apparatus 600 can also be used as a means of advertising, in which an advertisment that includes a picture of assailant 602A is displayed on display 651. Processor 650 generates an advertisment containing at least one picture of assailant 602A. The advertisment may, for example, depict a jail cell, with assailant 602A pictured behind jail bars in the advertisment, along with a caption such as “Crime doesn't pay: do the crime and you'll do the time”. In this way, the content of the advertisment is responsive to an input from camera 310.

FIG. 6B illustrates a version of the apparatus 600′ in which there is no camera. The radar device 610 senses the approach of assailant 602A′ and, in response, an advertisment is displayed on display 651. The advertisment is preferably responsive to movement of assailant 602A′. The dark dome 300 creates a conspicuously concealed imaging possibility so that rays 202L′ are of unknown fate to assailant 602A′.

FIG. 6C illustrates a version of the apparatus 600″ in which there is no camera or radar, but assailant 602A″ is still uncertain of the fate of rays 202L″.

A number of versions of the apparatus may be sold, rented, or deployed for use by large numbers of people wishing to be safe and secure, such that would be perpetrators of crime, or state sponsored terrorists, do not know which, if any, of the devices contain cameras.

FIG. 6D depicts a radar processing aspect of the invention. In FIG. 6D there is depicted seven different examples of Time-Frequency analysis together with corresponding Frequency-Frequency analysis.

Time-Frequency analysis makes an implicit assumption of short time stationarity, which, in the context of Doppler radar, is isomorphic to an assumption of short time constant velocity. Thus the underlying assumption of much of the traditional time frequency analysis is that the velocity is piecewise constant. This assumption is preferable to simply taking a Fourier transform over the entire data record, but we can do better by modeling the underlying physical phenomena.

Instead of simply using sines and cosines, as in traditional Fourier analysis, sets of parameterized functions may be used for signal analysis and representation. The well known wavelet transform is one such example having parameters of time and scale. The chirplet transform has recently emerged as a more general framework for signal representation. The first published reference to chirplets appears in “Vision Interface '91”, in a 1991 article by Mann, Steve and Haykin, Simon, entitled “The Chirplet Transform: A Generalization of Gabor's Logon Transform”, published by the Canadian Image Processing and Patern Recognition Society, on pages 205-212 of the proceedings for the conference in Calgary, Alberta, June 3-7, ISSN 0843-803X. This article teaches how to apply the Chirplet Transform to the analysis of radar signals. The article also discusses the characteristic “bowtie” shape of a Frequency-Frequency analysis (e.g. the FF plane of the chirplet transform) resulting from radar returns of accelerating targets, such as those depicted in the lower row of seven plots of FIG. 6D.

Chirplets include sets of parameterized signals having polynomial phase (e.g. piecewise cubic, piecewise quadratic, etc.), sinusoidally varying phase, and projectively varying periodicity. Each kind of chirplet is optimized for a particular problem. For example, warbling chirplets (W-chirplets), also known as warblets were designed for processing Doppler returns from floating iceberg fragments which bob around in a sinusoidal manner, as described in a 1991 article on chirplets, (the 1991 VI91 paper) where the varying phase of the w-chirplet matches the sinusoidally varying motion of iceberg fragments driven by ocean waves.

Of all the different kinds of chirplets, it is known in the art that the q-chirplets (quadratic phase chirplets) are the most well suited to processing of Doppler returns from land-based radar where accelerational intentionality is assumed. Q-chirplets are based on q-chirps (also called “linear FM”), exp(2πi(a+bt+ct²)) with phase a, frequency b, and chirpiness c. The Gaussian q-chirplet, ψₜ_{₀}_{,b,c,σ}=

$$\frac{1}{\sqrt{2 π} σ}$$

exp(2πi(a+bt_{c}+

$${ct}_{c}^{2} ) - \frac{1}{2} {( \frac{{t}_{c}}{σ} )}^{2} )$$

is a common form of q-chirplet, where t_{c}=t−t₀ is a movable time axis. There are four meaningful parameters, phase a being of lesser interest when looking at the magnitude of:

<ψₜ_{₀}_{,b,c,σ}|z(t)> (1)

which is the q-chirplet transform of signal z(t) taken with a Gaussian window. Q-chirplets are also related to the fractional Fourier transform.

The apparatus depicted in FIG. 6 may take various forms such as devices for assisting the blind, devices to output on vibrotactile actuators for assisting the blind or visually impaired, or backward looking devices to assist in having a “third eye” behind the wearer, in an area in which we are all blind. Thus the apparatus has many uses beyond use by the blind or visually impaired. For example, we are all blind to objects and hazards that are behind us, since we only have eyes in the forward looking portion of our heads.

A key assumption is that objects in front of us deserve our undivided attention, whereas objects behind us only require attention at certain times when there is a threat. Thus an important aspect of the apparatus is an intelligent rearview system that alerts us when there is danger lurking behind us, but otherwise does not distract us from what is in front of us. Unlike a rearview mirror on a helmet (or a miniature rearview camera with eyeglass based display), the radar vision system of FIG. 6 is an intelligent system that provides us with timely information only when needed, so that we do not suffer from information overload.

A key inventive step is the use of a rearview radar system, so that ground clutter is moving away from the radar when the user is going forward. In one embodiment (e.g. FIG. 6) this rearview configuration comprises a backpack in which the radome is behind the user, and facing backwards. However, the backpack configuration is in no way meant to limit the scope of the invention. For example, in mass production it would be expected that the radar antennas would be flexible antennas sewn directly into garments or the like. The device might also be implanted in the body, or it could comprise a subdermal patch antenna, or a Dermimplant (TM) patch or system affixed with Dermabond (TM) adhesive.

The system may have several variations including some embodiments having several sensing instruments, or multiple camera systems operating in various spectral bands, including infrared.

Dome 300 is preferably a radome also optically transmissive in the visible and infrared. Dome 300 further serves an aesthetic value, to help match the decor and help blend in with many places where the radome is worn, such as department stores, gambling casinos, and other settings from ordinary day-to-day living.

A general description of radomes may be found in http://www.radome.net/ although the emphasis on radomes of the prior art has traditionally been on radomes the size of a large building rather than in sizes meant for a battery operated portable system.

The apparatus of FIG. 6 is meant to detect persons such as stalkers, attackers, assailants, or pickpockets sneaking up behind the user. The apparatus can also be used to detect hazardous situations, such as arising from drunk drivers or other vehicular traffic.

It is assumed that attackers, assailants, pickpockets, etc., as well as ordinary pedestrian, bicycle, and vehicular traffic are governed by a principle of accelerational intentionality. The principle of accelerational intentionality means that an individual attacker (or a vehicle driven by an individual person) is governed by a fixed degree of acceleration that is changed instantaneously and held roughly constant over a certain time interval. For example, an assailant is capable of a certain degree of exertion defined by the person's degree of fitness which is unlikely to change over the short time period of an attack. The instant the attacker spots a wallet in a victim's back pocket, the attacker may accelerate by applying a roughly constant force (defined by his fixed degree of physical fitness) against the constant mass of the attacker's own body. This gives rise to uniform acceleration which shows up as a straight line in the Time Frequency distribution.

Examples following the principle of accelerational intentionality are illustrated in FIG. 6D. Seven examples illustrate the principle of accelerational intentionality, with Time Freq distributions shown at top, and corresponding chirplet transform Freq Freq distributions shown below.

A REST CLUTTER situation is shown in Time-Freq. plot 680 which depicts a radar return when the wearer of the apparatus 600 is standing still. The ridge 680A in the plot 680 shows that the frequency spectrum of the Doppler return is peaked at the origin (frequency of zero) for the entire duration of the three second measurement shown. Corresonding chirplet transform FF plot 690 depicts the characteristic bowtie-shaped return as peak 690A at the center of the FF plane, due to ground clutter.

A REST CAR situation is shown in Time-Frequency plot 681 in which a car initially parked behind the wearer is set in motion when its driver steps on the accelerator, so that a roughly constant force of the engine is exerted against the constant mass of the car, while the wearer of the radar is standing still. A ridge 681A along the origin corresponds to the ground clutter with respect to the stationary wearer. A ridge 681B corresponds to the accelerating car, initially set in motion at time 1 second. Corresonding chirplet transform FF plot 691 depicts the characteristic bowtie-shaped return as peak 691A at the center of the FF plane, as well as peak 691B showing a negative starting frequency (e.g. continuation of line segment of ridge 681B as a line goes into negative frequencies at time zero) and positive ending frequency.

A START WALKING situation is shown in Time-Frequency plot 682 in which the wearer stands still for one second, as depicted by ridge 682A, and then decides to start walking, as depicted by ridge 682B. The decision to start walking is instantaneous, but the human body applies a roughly constant degree of force to its constant mass, causing it to accelerate until it reaches the desired walking speed, which takes approximately 1 second. Finally the wearer walks at this speed for another one second, as evident by ridge 682C in the Time-Frequency plot 682. All of the clutter behind the wearer (e.g. the ground, buildings, lamp posts, etc.) is moving away from the wearer, so it moves into negative frequencies. Thus ridges 682B and 682C are in the region of negative frequencies. Corresonding chirplet transform FF plot 692 depicts the characteristic bowtie-shaped return as peak 692A at the center of the FF plane. Peak 692B has a positive starting frequency because the line segment of ridge 682B, when extended as a line, passes through a positive frequency at time zero in plot 682. The peak 692B has a negative ending frequency. Peak 692C has a negative starting and ending frequency since the line segment of ridge 682C is negative when extended as a line for the whole three second interval.

A WALKING scenario is shown in plot 683 in which the wearer is walking at a constant pace, so that all of the clutter has a constant (negative) Doppler frequency. Thus ridge 683A is in the negative side of the plot 683. Peak 693A of FF plot 693 has negative starting and ending frequencies.

A CAR HAZARD scenario is shown in plot 684. While the wearer is walking forward, a parked car is switched into gear at time 1 second. It accelerates toward the wearer. The apparatus 600 detects this situation as a possible hazard, and brings an image up on the screen in the wearer's eyeglasses. The hazard is detected by way of the manner in which ridge 684B shows up in chirplet transform FF plot 694. Ridge 684A is no cause for concern since this ground clutter is moving away as peak 694A at negative starting and ending freqeuncy. Peak 694B, however, indicates possible concern, with a positive ending frequency.

A PICKPOCKET scenario of plot 685 provides a rare but unique radar signature of a person lunging up behind the wearer and then suddenly switching to a decelerating mode (at time 1 second), causing reduction in velocity to match that of the wearer (at time 2 seconds) followed by a retreat away from the wearer. Ridge 685A shows ground clutter, corresponding to peak 695A of FF plot 695. Ridge 685B (corresponding to peak 695B), immediately followed by ridge 685C (corresponding to peak 695C) indicates a pickpocket signature.

A STABBING signature is indicated in plot 686 by way of ridge 686B and ridge 686C in which an assailant 202A lunges at the wearer of apparatus 600, and then an outstretched arm of assailant 202A swings into an even higher degree of acceleration. Acceleration of the attacker's body toward the wearer is shown as peak 696B in FF plot 696, followed by a swing of the arm of the assailant (initiated at time 2 seconds) toward the wearer, as indicated by peak 696C.

Ground clutter of ridge 686A shows as peak 696A.

A typical example of a radar data test set, comprising half a second (4000 points) of radar data is derived from a sampling of approximately 8000 samples per second, by way of a two channel analog to digital converter in processor 650. A satisfactory processor 650 includes a PC104 computer with an Industry Standards Association (ISA) slot adapter fitted with a Data Translation DT2811 analog to digital converter. Preferably, however, processor 650 is miniaturized and sewn into fabric, or Dermimplanted (TM) as part of the user of the apparatus.

Most radar systems of the prior art do not provide separate real and imaginary components and therefore cannot distinguish between positive and negative frequencies (e.g. whether an object is moving toward the radar or going away from it). The radar system of FIG. 6, however, provides in-phase and quadrature components, so that there is s complex-valued return signal.

Frequency-Frequency analysis (as described in the 1991 paper) arises from taking a slice through the chirplet transform, in which the window size σ is kept constant, and the time origin t₀ is also kept constant. The two degrees of freedom of frequency b and chirpiness c are parameterized in terms of instantaneous frequency at the beginning and end of the data record, to satisfy the Nyquist chirplet criterion described in the 1991 paper. In FIG. 6D we see a peak for each of the targets, or accelerational signatures of the target, such as the ground clutter (e.g. the whole world) moving away, along with other objects accelerating toward the radar.

Ground clutter tends to fall in the lower left quadrant, because it is moving away from the radar at both the beginning and end of any time record (window). Note that the pickpocket is the only kind of activity that appears in the lower right hand quadrant of the chirplet transform, so that whenever there is any substantial energy content in this quadrant we can be very certain there is a pickpocket present.

Due to the high frequency involved, such a system is difficult to calibrate perfectly, or even closely. Thus there is a good deal of distortion, such as mirroring in the FREQ=0 axis. Thus there is, in a plot of real versus imaginary data a strong correlation between real and imaginary axes, as well as an unequal gain in the real and imaginary axes. DC offset also gives rise to a strong signal at f=0, even when there is nothing moving at exactly the same speed as the wearer (e.g. nothing that could have given rise to a strong signal at f=0). Rather than trying to calibrate the radar exactly, and to remove DC offset in the circuits (all circuits were DC coupled), and risk losing low frequency components, these problems are mitigated by applying a calibration program to the data. This procedure subtracts the DC offset inherent in the system, and computes the inverse of the complex Choleski factorization of the covariance matrix (e.g. covz defined as covariance of real and imaginary parts), which is then applied to the data. Thereafter, the calibrated radar data provides an approximately isotropic circular blob centered at the origin when plotted as REAL versus IMAGinary. This calibration also removes the mirroring in the FREQ=0 axis.

FIG. 6E shows an embodiment of the invention with chestworn display 650, attached to a chestworn mount 650M. Ordinarily the display 650 displays an image responsive to an output from a wearable camera, as a wearable advertisment that other people can see or read. Display 650 may also provide a comforting message such as “For YOUR protection, a video record of you and your establishment may be transmitted and recorded at remote locations.”. Alternatively, a short message such as “YOU ARE ON CAMERA” may be displayed to comfort assailants 602A into being good law abiding citizens. Preferably an advertisment is generated in which pictures of assailant 602A are included as part of the content of the advertisment.

Display 650 may be viewed by the wearer as well as assailant 602A. The wearer sees display 650 by way of a mirror 600M on eyeglasses 600E. Eyeglasses 600E can also house a camera 600C to reflect off the backside of the mirror 600M, where mirror 600M is a double sided mirror or beamsplitter. This will provide an EyeTap camera signal responsive to rays of eyeward bound light. Thus dome 300 will no longer be necessary, or may simply provide an additional conspicuously concealed imaging possibility. A forward facing eyetap camera together with a forward facing display 650 will help to make people standing in front of the wearer of the apparatus feel comfortable, knowing that there is safety and security, because they will be able to see their own picture as part of advertisments such as anti-crime advertisments presented on display 650. Material displayed thereupon in a delayed fashion, and freeze-frame fashion preferably emphasize the storage, recording, and transmission capabilities of the system, in order to emphasize the element of safety and security afforded by the system.

Instead of the mirror, a downprism the eyeglasses 600E worn by the wearer, may also make the image of display 650 appear upside down to the wearer, and thus cancel the upside down nature of the image, so that the wearer can see it as if it were rightside up. The downprism preferably also provides left right reversal from what would normally be seen in a mirror 600M so that the image will not appear left right reversed. The downprism flips the image upside down, and alows the wearer to see down, into the chestworn display 650 in a normal sense, and thus use chestworn display 650 as a viewfinder to aim camera 600C at persons in front of the wearer while these persons can also see material displayed on the display 650. Alternatively, a second display inside eyeglasses 600E may be used for this viewfinder purpose.

In another embodiment of the invention, display 650 flips up so that the wearer can look right down at it, so that a downprism or mirror 600M is not needed. Preferably a tilt sensor in display 650 flips the image upside down when the display 650 is tilted up for being viewed by the wearer. In a preferred embodiment, a track or mount 650M allows display 650 to slide down and flip out, so that it is visible to the wearer. The tilt sensor in display 650 thus takes the upright image 650TV and flips it upside down so that it appears as image 650UD when the display 650 is oriented for being viewed by the wearer. The arrow of image 650TV and 650UD indicates the direction toward the top of the image content. Mount 650M also helps to secure display 650 so that it can remain in place while giving the user hands free use of the apparatus.

In a preferred embodiment, mount 650M is a front part of a backpack comprising a computer in a housing such as dome 300 at the back of the backpack. In another embodiment, mount 650M attaches to the two straps of a backpack of dome 300. In another embodiment, mount 650M is connects to two straps of a backpack at the sides, and to a sternum strap of a backpack at the top. In this way, mount 650M is securely held at the top and sides, which is where most of the need for support is.

Another desirable feature of the apparatus is that it may be fitted with an anti-complicity system. An example of an anti-complicity system is means for fastening the apparatus to the wearer in such a way that it cannot be removed without an appropriate procedure. For example, with regard to eyeglasses 600E, if the eyeglasses are fitted with a comfort band that goes behind the head, and the comfort band is held in with security screws, the wearer can install the apparatus in a locker room, and leave the key in his or her locker. When others ask the wearer to remove the apparatus the wearer can have an articulable basis upon which to deny this request, based on the fact that the equipment needed for removal of the apparatus is left behind in the locker room.

Such an anti-complicity system may be useful for mail delivery clerks, for example, who can articulate their inability to remove the apparatus without returning to an employee locker room. Thus assailants 602A must choose between tolerating the apparatus or accompanying the wearer back to an employee locker room, where the assailant may risk getting caught, detained, or forced to undergo certain procedures such as decontamination.

FIG. 6F shows an embodiment of the invention with an advertisment generator. A video switcher 600SW is responsive to two video inputs, one from an eyetap camera 600C and another from a camera in dome 300. A capture device 600CAP captures pictures from the one or more cameras (e.g. there may or may not necessarily be a camera in dome 300). An orbits stabilizer 300OS uses the video orbits algorithm, known in the art and described in http://wearcam.org/orbits/index.html to stabilizer the video stream for eyetap camera 600C, and possibly from one or more other cameras such as in dome 300. A comparametric stabilizer 600CS stabilizes the tone scale of the images, and the stabilized images are fed to a processor 600PROC. The processor 600PROC generates an advertisment containing content from the video signal from the eyetap camera 600C. Optionally, the coordinate transformation of orbits stabilizer 300OS may be undone by orbits destabilizer 600DS, so that the material with the advertisment matches the possibly jerky camera motion of eyetap camera 600C. Alternatively, orbits destabilizer 600DS is separately responsive to a camera in dome 300, or a camera mounted on display 650. In this way, the display 650 appears as a window into a virtual world of the advertisment. Tonal range is also similarly restored, by comparametric destabilizer 600CD, and the signal is sent to display driver 600DISP.

In one embodiment, the display 650 is worn on the side of the body, and forms a scrolling advertisment in which the rate of scrolling is equal to the speed of the body of the wearer of the display 650, so that the advertisment appears as if it were stationary, while the display 650 has the appearance of a window moving along to reveal various parts of the stationary advertisment. Thus, for example, display 650 can function as a window into a long prison corridor, scrolled along, in which images containing a likeness of assailant 602A are shown behind bars in the prison. Words can be scrolled by as if on a scrolling LED sign, and the rate of scrolling can be the negative of the velocity of the wearer of the apparatus, so that persons looking at the wearer see the letters as if standing still floating in free space. Thus long messages can be striped through the space like ribbons of text, and the messages may include references to the disadvantages of criminal activity, or slogans such as “Advertising is theft of personal solitude”, or Jenny Holzer quotes or other favorite quotations and scholarly discourse.

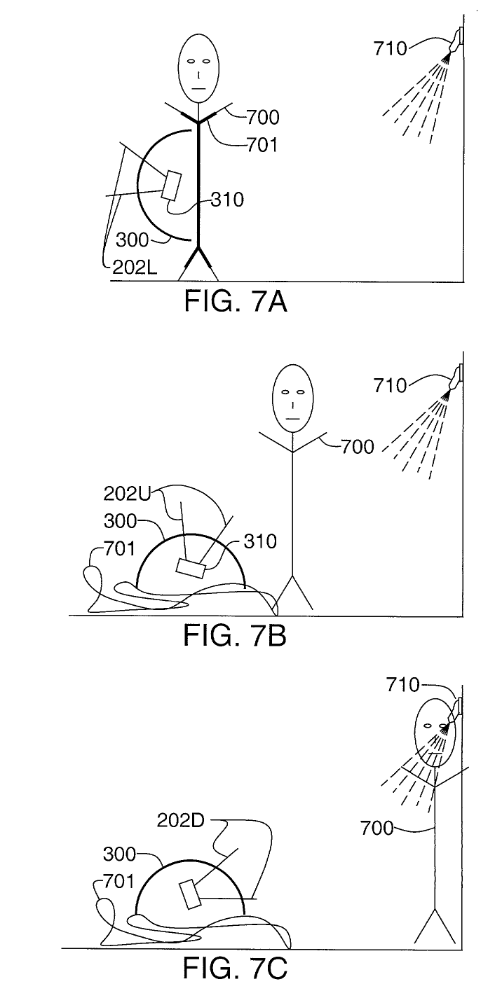

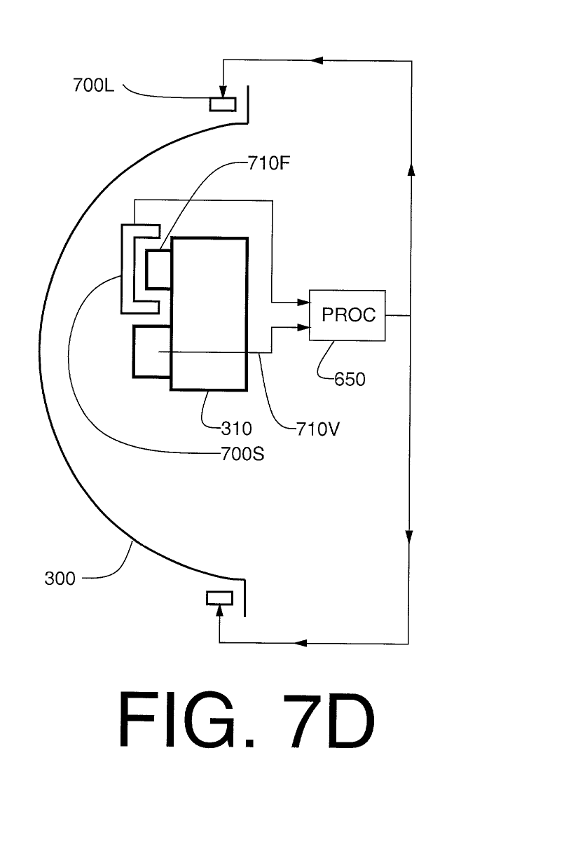

FIG. 7A shows an embodiment of the invention in which the wearer of the apparatus may still be protected even when the apparatus is removed.

A drawback of the invention is that the high voltage electric circuits may need to be removed during times of bathing, such as when showering or splashing around in a public pool, or the like.

A bathroom is dangerous place, where a person can slip and fall.

Public baths, pools, and the like, are also dangerous because of a possibility of drowning. It has been observed, for example, that “In the Netherlands about 10 people drown every year in public baths.” with the government's proposed solution being “underwater cameras to spot drowning bathers” (cache or archive of article in http://wearcam.org/envirotech/public_baths_cameras_prevent_drowning000515.html). Other pools, such as the North Toronto Memorial Community Centre in Toronto, Canada, have also installed surveillance cameras that have the possibility of being remotely monitored from France.

However, rather than rely on state sponsored surveillance (which many fear may promote a police state), it is preferable to have a more individually based form of personal safety.

The general spirit of the invention is to allow individuals to look after their own safety to a greater degree, rather than to ask governments to install cameras throughout cities public areas.

Thus FIG. 7A depicts a wearer 700 of apparatus 701 comprised of sensor such as camera 310, in housing such as dome 300, responsive to rays 202L. A bath 710 may comprise a shower bath., toilet, bath tub, bathroom, bathing environment, or swimming bath, such as a municipal swimming bath in which the apparatus 701 might be removed.

The apparatus 701 is responsive to rays 202L of light aimed outward behind the wearer 700, and preferably pointing up slightly so as to show the face of an attacker or assailant 202L during normal wearing of the apparatus 701.

FIG. 7B depicts wearer 700 no longer wearing the apparatus 701. The wearer removes the apparatus, and places it on a flat surface. In a private bath this flat surface may, for example, be a bathroom counter, or shelf or table within the bathroom of a private residence. In a public bath, this flat surface may, for example, be the pool deck, or benches around, and in view of the pool, such as, for example, the empty bleachers or spectator stands typically built around pools for use during races or competitions.

Because dome 300 is an optical surface, which is easily scratched, it is likely that when being removed a wearer would tend to place the clothing or other apparatus upon which dome 300 is attached in such a manner that dome 300 would face upward. Thus, for example, a wearer who purchased such a personal safety device would likely have the common sense not to place the dome face down on the rough cement surface of a pool deck where it might get scratched.

Accordingly, since the wearer is likely to place the apparatus with dome 300 facing upward, it will become responsive to rays 702U of light, because camera 310 is pointing upward. This skyward view may be of little help in protecting the wearer either from attack or from personal monitoring for slip and fall injuries or drowning.

In particular, rather than relying on surveillance by government installed cameras in the public baths, a wearer of the apparatus may prefer to be monitored by friends and relatives. A spouse, for example, may provide remote monitoring of a weak swimmer. An elderly or infirm wearer may also wish to be remotely monitored by family members rather than by government officials or police, especially when not fully clothed (as in a bath or pool).

Thus a goal of the invention is a community-based self-surveillance rather than state-sponsored surveillance, especially in areas such as public baths where privacy and autonomy may be seen as an important consideration.

FIG. 7C shows the bath 710 in use. The wearer 700 has removed the apparatus 701. A key inventive feature of the apparatus 701 is that it changes mode of operation when it is removed from the body. In this example, camera 310 drops down so that it points along the axis of the floor when dome 300 is facing up. Thus in this downward pointing state, it becomes responsive to rays 702D of light, so that it has a view of the wearer 700 when the wearer is not wearing apparatus 701.

The downard pointing direction of rays 702D is actually what would have originally been upward pointing if worn, so that as long as the wearer 700 points apparatus 701 with the top toward where he or she plans to go, there will be coverage of the wearer 700 when he or she is not wearing the appartus 701. The nonworn mode of apparatus 701 in this simple example may be gravity driven, so that camera 310 merely falls down, against a stop. Thus camera 310 swings between pointing backwards and pointing upwards, such that gravity keeps it pointing backwards when worn, and pointing upwards (now downwards when taken off with dome 300 facing up) when not worn.

Other nonworn modes may include zoom or field of view changes. For example, camera 310 may zoom out to provide overall wide field of view coverage of a large pool.

Additionally, a pan tilt head in apparatus 701 can allow a remote caregiver to remotely control the aim and zoom of camera 310 to provide satisfactory supervision of wearer 700 while wearer 700 is in the vulnerable state of not wearing the apparatus 701. Moreover, wearer 700 may wear a device that is detected by apparatus 701 so that it can keep wearer 700 in field of view. The device may be a wristband, or special swimsuit with transmitter, so that the pan and tilt of the camera 310 are controlled automatically. In this way the device can also be used by wearer 700 to capture information for swim stroke improvement by later review, or for a coach to review with the wearer 700.

FIG. 7D shows an embodiment of the invention with informatic light source flash-lamp illuminator.

Commonly used cameras that have built in flash systems tend to produce glare off the inside of a dome when placed inside the dome 300. Thus built in flash 710F of camera 310 is covered with a special sensor 700S that is also opaque so that it blocks light from built in flash 710F. Thus camera 310 can remain on the automatic setting and built in flash 710F fires when necessary (e.g. in low light, or the like). Because dome 300 is dark, camera 310 may fire built in flash 710F more frequently than normal.

Sensor 700S measures the output of built in flash 710F such that one or more external light sources such as lamps 700L can be driven with a quantity of light proportional to the amount of light that would have been produced by built in flash 710F but for the fact that built in flash 710F is blocked. Lamps 700L may comprise a single photographic flash system mounted outside dome 300, or lamps 700L may comprise multiple flashtubes, one or more white LEDs receiving a short pulse of light, infrared LEDs, or the like.

This correct proportionality may be governed by processor 650. Moreover, processor 650 may also modulate the output of lamps 700L with information, such as packet data responsive to picture signal 710V from camera 310. In this way, the flash of light from lamps 700L can serve as a beacon to transmit a previously acquired image, such as the last image taken by camera 310. In this way the same light source used to illuminate assailant 202A may be used to transmit a previously acquired image, such as another image of assailant 202A.

Other similar personal safety devices, or other elements of a Witnessential Network (TM) can receive pictures transmitted in this manner. Because the light output of lamps 700L is often quite high, such as to light up an entire room for a brief instant, the chance of such information bearing light escaping from the camera system is quite high.

Accordingly, in the context of the FoF model of FIG. 4 and 5, the flash of light can be useful in this way.

Moreover, an infrared camera 310 or a camera 310 that is at least somewhat sensitive to infrared light, such as near infrared LEDs used for lamps 700L may benefit from the illumination therefrom. In this way, lamps 700L serve as invisible infrared illuminators as well as transmitters of picture information. Accordingly very little energy is wasted because packets of information bearing light are used to illuminate subject matter in view of camera 310. The problem of glare off the inside of dome 300 is also solved because lamps 700L are mounted outside the dome. Lamps 700L may be decoratively attached around the periphery of dome 300, to appear as rivets or bolts that hold dome 300 to a garment, or the like. Alternatively, lamps 700L may be concealed around dome 300.

Lamps 700L may also serve other decorative function such a light chaser around dome 300 to mimic the car alarm light chasers which call to mind safety and security. Such a safe and secure aesthetic may also help to reduce crime.

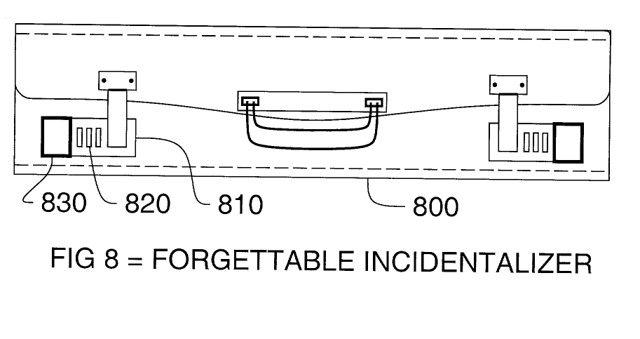

FIG. 8 shows an embodiment of the invention mounted in a briefcase 800 to be carried by individual 201A. Within the context of the business method disclosed herein, the briefcase 800 is preferably at least partially owned by an entity other than the owner, or at least some aspect of its function is either unknowable, or articulably unknowable by individual 201A. If the briefcase is purchased by the owner, the individual 201A (owner) may choose to sell a partial interest in the briefcase another entity so that the owner can truthfully say it is not (entirely) his briefcase. Such a business arrangement can work as a freetime corporatizer.

Since briefcases in general are symbolic of business, the briefcase is therefore an ideal article to use for freetime corporatization. Additionally, an individual 201A can request, through the business model of this invention, employment as a courier to deliver a sheet of paper from a Safety Management Organization (manager, or the like) to whereever he happens to be going (e.g. for a vacation, or the like). This request therefore can make the briefcase 800 mean business. Preferably the piece of paper is a confidential document and preferably the individual 201A is bound not to disclose the confidential document to strangers. Accordingly, the briefcase 800 has locks 810 along with thumbwheel combination lock inputs that comprise a denializer 820. The denializer 820 provides the individual 201A with a convenient way of forgetting the combination number so that the individual 201A needs remote assistance from a manager to open the briefcase. Thus when required (such as by an official) to open the briefcase 800, the individual provides the official with a submission interface which takes the form of two fingerprint scanners 830.

The system has at least one mode of operation in which the briefcase cannot be opened by the owner or person carrying it. For example, there may be two combination numbers, a first one which opens the briefcase and another which additionally requires thumb prints from a person other than the owner to open the briefcase. If the owner conveniently forgets the first combination number, then the owner needs someone else such as assailant 202A to assist by providing additional thumb prints to open the briefcase 800. This need is accomplished by previously storing thumb prints by the briefcase, so that the system rejects the owner's thumb prints. This indirectly allows the owner to force the assailant 202A to be fingerprinted in order to fulfill the assailant's request for a search of the case. Directly, the owner is bound by the situation (having forgot the direct opening number) to the freedom of submissional reciprocity. Thus the user is bound to require the assailant 202A to be submissive in order for the user to submit to the assailant's demands for a search of the briefcase 800. Such a situation is referred to as submissivity reciprocity.

This embodiment of proceduralization makes the process of opening the case a collaborative process rather than one in which individual 201A is just following the orders of assailant 202A. Alternatively, a remote manager may be involved to further proceduralize the interaction.

There may be, in some embodiments, a third combination number that requires remote rather than just local help. The third combination number is only known to the remote manager, and a method of doing business of personal safety includes the steps of:

When an assailant 202A demands that the owner open up briefcase 800, the owner informs the assailant that only the remote manager knows the combination to open the case.

The owner provides assailant 202A with means for contacting the remote manager.

If the assailant contacts the remote manager, the manager informs the assailant 202A that the combination cannot be given to strangers, or to the owner of the briefcase 800, and that the assailant needs to fax a photocopy of the assailant's identification, and that the assailant needs to agree to certain terms such as a Non Disclosure Agrement (NDA).

If the assailant complies by sending a photocopy of identification and agreeing to the terms, the remote manager provides the assailant with the third combination number to open the case, or to allow the owner of the case to open it.

Preferably briefcase 800 contains a video camera. In a preferred embodiment there is a tilt switch, so that the video camera begins recording when the briefcase 800 is set on a flat surface, such as when being set down for inspection by assailant 202A. In one embodiment, a PC104 computer in the briefcase is booted up when the briefcase is set on a fiat surface, so that images are recorded locally as well as transmitted to the Internet as live video.

Preferably an upward aimed video camera in a top panel of briefcase 800 has a view of a person standing in front of the briefcase, so that a person inspecting the briefcase will be recorded.

In another embodiment, there are two video cameras, one inside the briefcase and another outside the briefcase. A tilt switch in the top portion of the briefcase operates the camera in the top portion of the case when the top portion is parallel to the ground, and a second tilt switch in the lower portion of the case together with the first tilt switch operate the camera inside the case when the two tilt switches indicate different orientations (e.g. to indicate the case is open).

In this way a video record of the search of the briefcase 800 is made by way of the camera that is inside the case. Such a briefcase therefore provides protection against, or at least documentation of, theft of items from the case by persons demanding to search the contents of the case.

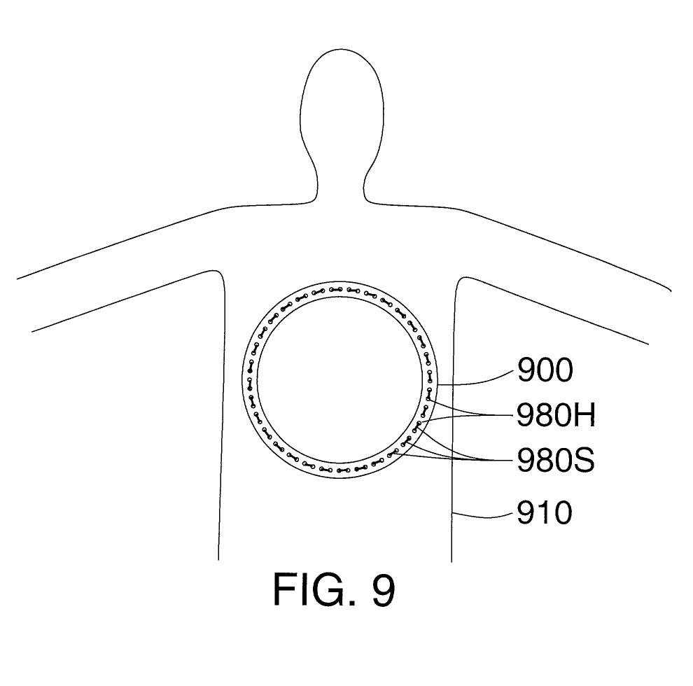

FIG. 9 depicts a hemispherical smoked acrylic dome 900, as typically found on the ceiling of a gambing casino or department store. This some makes a decorative fashion statement by being resituated in a disturbing manner on a garment 910. Holes 980H are drilled around a lip of the dome 900. Stitches 980S hold the dome in place on the garment 910.

The dome 900 forms the optical housing for a conspicuously concealed imaging possiblity.

As a defiant fashion statement, the dome may be very large. For example, a 12 inch (approx. 305 mm) diameter dome can be sewn onto the back of a shirt, or heavy jacket, and has a wonderful aesthetic appeal. For the front of a shirt or heavy pullover, an 8 inch (approx. 203 mm) dome has a better aesthetic value. Such domes are far bigger than necessary since many cameras are only one centimeter across (e.g. less than half an inch across) and thus are more than ten times smaller in diameter (100 times smaller in area and approximately 1000 times smaller in volume) than the dome, yet the conspicuous nature of the dome makes a powerful fashion statement, especially given the close match to the decor of many department stores and the like.

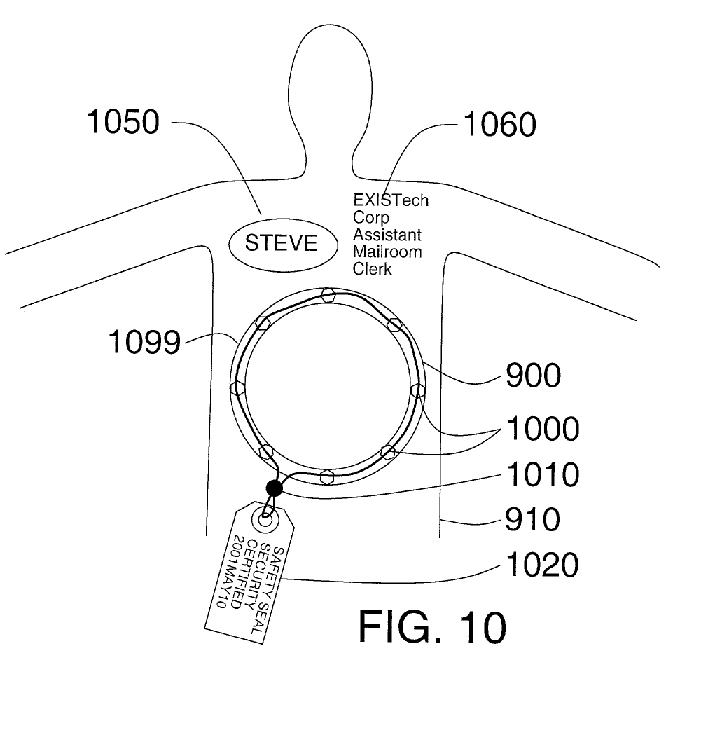

FIG. 10 depicts an alternate embodiment where large nuts and bolts 1000 go through holes in a lip of the dome 900 to secure it with metal rings 1099 on the inside and outside of the garment. Nuts and bolts 1000 provide an aesthetic of security, providing the appearance of in impenetrable portal. The portal metaphor connects the ideas of underwater portals in ships, to the idea of surfing the Internet and its vast sea of information. Not surprisingly the dome 900 may also be a portal into cyberspace, by way of a webcam concealed within.

Security wiring passing through some or all of the nuts and bolts, is secured with a lead seal 1010, where a tag 1020 is also attached. This conveys, whether at the conscious level, or the subconscious, that the wearer cannot open the device. The easthetic is very similar to a gas meter, or hydro meter, or taxicab fare meter, being tamperproof so that the owner (homeowner, cab owner, or the like) cannot open it.

Therefore, it is readily apparant that the wearer cannot open dome 900, or at least articulably allegible by the wearer that the dome is a tamperproof unit. Moreover, the wearer can conveniently not know whether or not a camera is contained therein.

Preferably nuts and bolts 1000 form locations for mounting infrared LEDs or other infrared light sources, around the periphery of the dome 900. Therefore dome 900 is preferably made of a material that is dark or opaque to visible light, and very transparent to infrared light, with there being a conspicuously concealed infrared imaging possibility therein.

The nuts and bolts 1000 may also have affixed to them pointers, like the pointers on truck tire bolts, to further call to mind a safety aesthetic. Other themes such as a wheel theme, may appeal to automobile or truck enthusiasts.

Subservience indicia 1060 may indicate a low rank, such as Assistant Mailroom Clerk or Assistant Filing Clerk Trainee. Thus an individual may benefit from the empowerment of self demotion by wearing the uniform in ordinary situations as a simple fashion statement.

A name tag 1050 also adds to the fashion sense of the garment.

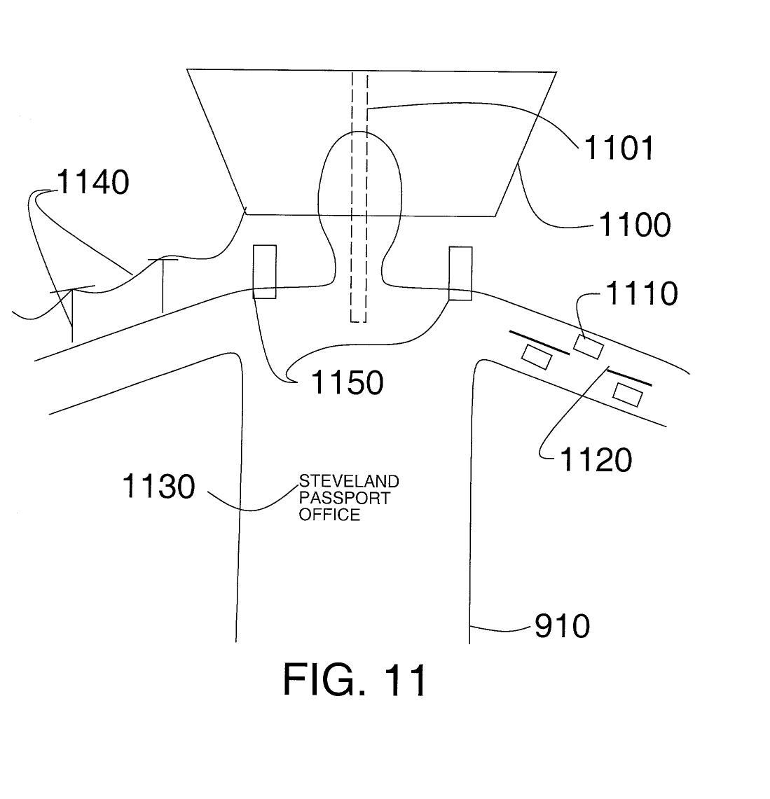

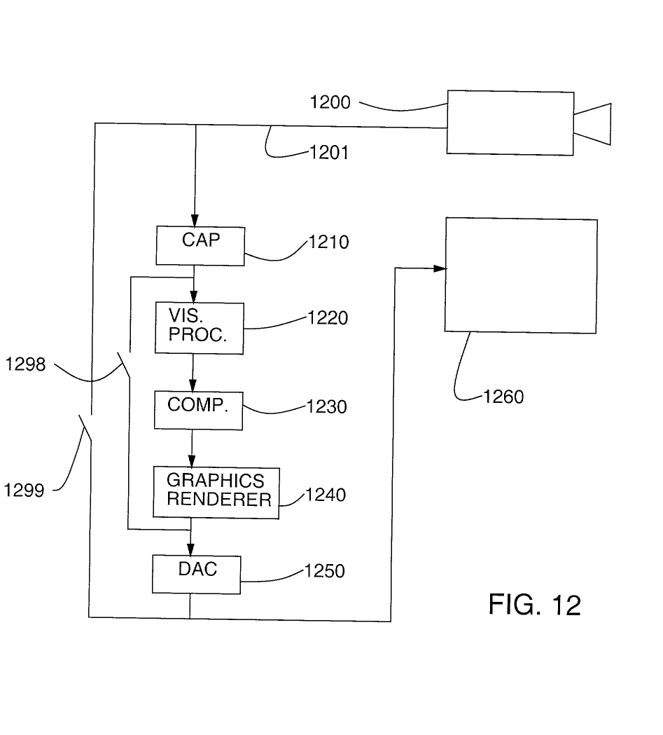

FIG. 11 shows a theatrical performance outfit for satire of bureaucracy. The user wears a country as a garment 910, such as is indicated by indicia 1130. The country may have any desired name, such as “C-LAND”, “STEVELAND”, “UNITED STATES OF STEVE”, or the like.

A map of a country may be indicated on a garment, to show that the person's body is being its own sovereign nation state.

While the country need not be built to scale, many elements of the country are preferably built to approximately 1/12 scale. Inhabitants 1150 of the country may be dolls, such as Ken (TM) and Barbie (TM) sewn to the shoulders of the wearer of the country.

To emphasize that this is in fact a country, with a passport office, and to satirize bureaucracy, surveillance, photo ID cards, and the male gaze, it is preferable that inhabitants 1150 might be engaged in the act of producing a passport. For example, a Ken (TM) doll may be situated behind a small scale model counter of a miniature passport office on the wearer's left shoulder, whereas a Barbie (TM) doll might be situated in front of an ID card camera on the wearer's right shoulder.

Preferably the Ken (TM) doll can be turned around 90 degrees so that he can photograph real people who are an audience to the wearer's performance. Thus persons wishing to converse with the performer can be told that they must first apply for a passport before being allowed to talk to the performer. An official talking to the performer may thus be told that he needs to get a passport, and the performer can then turn Ken (TM) doll to face the official and then it will be a matter of Ken (TM) doll photographing the official and a small wearable printer can print out a miniature passport photo ID card that the performer can hand to the official.

The passport office has a roof 1100 overhead, and the roof is also over the head of the performer wearing the apparatus. The roof portion of the apparatus is supported by support 1101 which is connected to a backpack. The backpack also houses the computers needed to run the body-worn country.

The is made as a 1/12 scale suspended ceiling. Instead of 4 (approx. 122 cm) foot long fluorescent lights, there are 4 (approx. 102 cm) inch long miniature fluorescent tubes. A satisfactory tube is the 4-inch T1 made by Kino Flo. Tubes are sold in “T” units where one “T” is ⅛ inch (approx. 3.2 mm) Normal ceiling tubes are typically 12T and 4 feet long so the 1T tube that's 4 inches long is exactly 12 times smaller in both length and diameter.

Ceiling tiles of size 2 inches by 4 inches (approx. 51 by 102 mm) are therefore affixed to ceiling 1100. Some of the ceiling tiles are made of smoked acrylic, just like in department stores where some ceiling tiles are smoked acrylic to create a comforting sense of security.

Additionally, some 2 inch (approx. 51 mm) diameter dome cameras are installed on the ceiling. These are exactly 1/12 the size of standard 24 inch (approx. 61 cm) diameter ceiling domes. The so-called “2 inch dome” is very popular and readily available.

Now let us suppose that the wearer of the apparatus meets an official. The wearer might remark, when asked what the ceiling domes are, that they are for security, and that “people under my roof, such as Ken (TM) and Barbie (TM) want to feel safe and secure, and since you are also under my roof, you will also feel safe and secure, but criminals will no doubt feel paranoid. However, in this country you need to abide by the laws of the land, and the laws require that anyone under this roof be under surveillance.”.

The country also has telecommunications, comprised of miniature telegraph poles running along the right arm of the wearer. Actual wiring running on the telegraph poles connects to various surveillance cameras on the poles to the wearable computer in the backpack.

Miniature cameras of today's generation are approximately 1/12 the size of traditional pole mounted surveillance cameras, adding further to the beautiful fashion statement afforded by the apparatus.

Highways connect the city together. Generally it is not possible to maintain the 1/12 scale model entirely, so the roads are done at a smaller scale, such that the telegraph poles do not stick out so high.

STEVELAND also has a radio station and the smaller antenna transmits video in the UHF band around 440 MHz over amateur packet radio at 56 kbps. However the antenna is fashionably done in the style of a real AM radio station. A highway running down the left arm of the wearer has cars 1110 and a dotted line 1120 running down the middle of the road.

STEVELAND also has various billboards, some of them being LED billboards, whereas others are made from miniature flat panel television screens that form what amount to giant billboards along the roads in STEVELAND scale.

Flags may also fly proudly throughout the garment to show the sovereignity of STEVELAND.

Small toy guns, such as mini squirt guns, water pistols, and toy soldiers may be lined up along the arms and shoulders, showing a right to bear arms for national security. An irrigation system may also be installed, along with a spray park, or “sprayground” that can shoot water up to 30 inches (approx. 76 cm) in the air (30 feet, or approx. 914 cm in STEVELAND scale). A water reservoir in the backpack serves the needs of STEVELAND and ensures that anyone getting close to the wearer gets totally soaked. Of course the TV sets, etc., need to be sealed, so that the 480 to 800 volt lines therein do not become laden with water.

Flower beds with real vegetation may also be planted on the garment, so that the irrigation system can be put to good use. The irrigation system may also come on randomly so that if persons get too close to look into STEVELAND, they get squirted by the system.

FIG. 12 shows a wearable advertising system. WearCam 1200 (wearable camera system or EyeTap system) is operably connected by way of connection 1201 to a capture device 1210, supplying picture information to a vision processor 1220. Vision processor stabilizes objects, and with simple object recognition provides stabilized coordinate frames, as described in IEEE Computer (http://wearcam.org/ieeecomputer) Steve Mann, “Wearable Computing: A first step toward personal imaging”, IEEE Computer, Vol. 30, No. 2, pages 25-32, February 1997.

A computer system 1230 generates an advertisment suitable for being viewed by a person or people in front of the wearer of the apparatus. The ad is generated such as to contain the person or people in front of the wearer. The ad will therefore ensure their attention because it depicts them in the ad. A graphics engine 1240 renders an advertisment containing the target audience as subjects in the ad. A digital to analog converter 1250 outputs to a wearable display 1260. The display 1260 may be digital video but ultimately outputs light in some form perceptible to the audience.

Additionally, a bypass mode switch 1298 serves as diagnostic function to debug the system. A second bypass mode switch 1299 directly connects the WearCam 1200 to the display 1260.

If the display and camera are compatible (e.g. both being NTSC) then the bypass mode is useful during rebooting of the system so that people first see themselves on the display (getting their attention) and then they see the ad when the bypass switch 1299 disengages bypass mode.

Preferably processor 1220 and computer 1230 perform subject tracking and ego-motion of the wearer so that the apparatus can sustain the illusion that display 1260 is a small window into a larger space.

Thus as the wearer moves around, the window “paints” out a larger advertisment. Especially in a dark room or outdoors late at night, the advertisment is very captivating because the persistence of human vision allows the ad to be clearly seen. Even a simple row of LEDs on the wearer's garment (preferably a black garment) can “paint” a picture of the subject when the wearer runs past the subject in the dark.

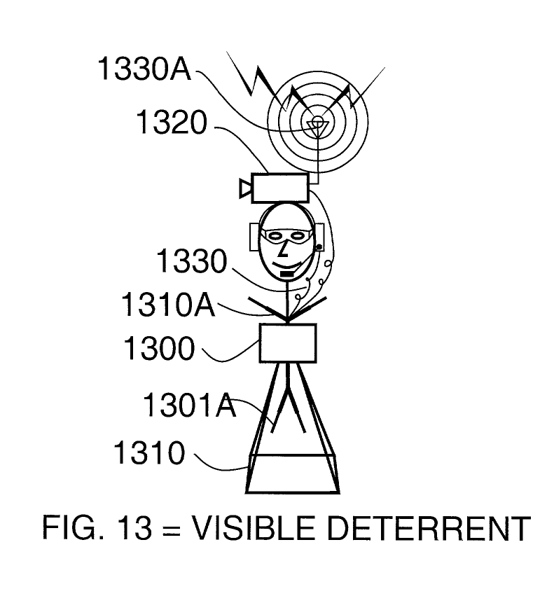

FIG. 13 shows a visible deterrent worn by individual 1301A. A wearable camera 1320 is preferably covertly concealed in eyeglasses, so that the camera itself is not visible. Wireless communications means such as by antenna 1330A is preferably also concealed. A chest worn miniature video projector 1300 projects an image from camera 1320 onto the floor 1310 in front of the wearer's feet. Thus the wearer (individual 1301A) may look at a subject such as an official or a clerk and capture a freeze frame image of the clerk, and then project this image onto the floor as projected image 1310. The image is projected in front of the feet of the wearer, while the wearer is walking forward. The clerk can see his face on the floor in front of the wearer's marching feet. This establishes a visible deterrent to the clerk that prevents the clerk from committing criminal acts. Additionally, other indicia and messages may be displayed on projected image 1310, such as “Picture Transmitted Successfully—Remote Archive Successful in Five of the Thirteen Designated Countries.”.

Other messages such as “For YOUR protection, a video record of you and your establishment may be transmitted and recorded at remote locations—ALL CRIMINAL ACTS PROSECUTED.”, or “Misleading advertising is a crime!”, or the like, may be displayed together with the image of the clerk.

Preferably a flame retardant uniform 1310A is worn to avoid adverse effects of light output from the projector. Since the projector is pointed at the ground, there is also avoided the problems of shining bright light directly at people. A typical distance from the waist to the ground will be close enough that a projector such as that made by Plus Corporation, used for giving lectures will be quite bright when the light is concentrated at close range. Therefore, even on black ashphalt such as on a road or parking lot, or in areas that are brightly lit, the projected image will still be quite visible.

The invention is particularly useful with a captive audience, in much the same way as advertising to a captive audience has been done in the art.

Advertising to a captive audience is well known in the art. For example, advertisements above urinals and in toilet compartments are well known. Since a person must eventually use a toilet, there is a captive audience to these advertisements, as well as other advertisements throughout the environment.

Therefore, the proven success of captive audience advertisment in the environment can now be brought to the wearer's own space. Additionally, the individual 1301A may display advertisments and other visual detritus for the enjoyment of a clerk, especially if the clerk is a captive audience, as might hapen when the clerk works somewhere and cannot leave the premises because of duty (e.g. a clerk working in an official role).

This situation is especially effective if individual 1301A is bound by an agreement with advertisers that requires him to display the advertisements, so that he is an employee acting out the requirements of a remote SMO when displaying advertising material in public.

In some embodiments, projector 1300 also has a second camera (in addition to wearable camera 1320). The second camera in the projector tracks the ground, and ground position. The second camera looks at the ground in a getting of lesser output of the projector (e.g. in a different spectral band, or in a blanking interval of the projector, or the like). Then a wearable computer moves an image bitmap around and indexes into the bitmap with the projector being a moving window thereto. Thus subjects watching the projected image see an image stabilized with respect to the ground. If the wearer is walking forward the image scrolls backwards so that text, graphics, and other materials appear as if they are affixed to the floor, ground, sidewalk, road, or the like.

The apparatus of this invention allows the wearer to enjoy the benefits that normally only go to building owners. Benefits include safety, security, and the ability to not interact with strangers, as well as the ability to be bound to the freedoms that ordinarily only go to building owners or others who can be bound by a remote manager.

Moreover, just as buildings often have video surveillance systems and biometrics, the user of the apparatus also has a similar personal safety device, that keeps a record of interactions between the user and his/her environment.

In many ways, the apparatus may be thought of as a building built for one occupant. The apparatus may be of particular benefit to the homeless, who have no place to call their own, and who are often stopped and asked for identification by people who do not show them identification.

The invention also provides a method of doing business in which an individual is bound to freedom, or in which the invidual need at most engage in a mutually (reciprocally) submissive activity rather than a wholly one-sided submissive activity.

From the foregoing description, it will thus be evident that the present invention provides a design for a personal safety and security system. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

What I claim as my invention is:

1. A personal safety system, comprising:
a plurality of personal safety enhancing devices for being provided to users, each of said plurality of personal safety enhancing devices comprising:
one of:
a camera installed in a concealed manner in a wearable conspicuously concealed imaging possibility housing, and a transmitter for transmitting pictures taken by said camera;
a wearable conspicuously concealed imaging housing lacking a camera,
a network for receiving pictures transmitted by said transmitter,
said personal safety system comprising at least one of said personal safety enhancing devices comprising a camera installed in a concealed manner in a wearable conspicuously concealed imaging possibility housing, and a transmitter for transmitting pictures taken by said camera.

2. A personal safety system including the features of claim 1, said personal safety system including a conspicuous annunciator located in said housing.

3. The personal safety system of claim 2, where said annunciator provides a decorative pattern for inducing persons to turn their faces toward said housing to look at said decorative pattern for being photographed by said camera.

4. The personal safety system of claim 2, where said annunciator provides a decorative mesmerising light chaser pattern for inducing persons to turn their faces toward said housing to stare at said decorative pattern for being photographed by said camera.

5. A personal safety system including the features of claim 1, said personal safety system including a safetycharm that includes said housing.

6. The personal safety system of claim 5 said safetycharm having a concomitant articulable basis upon which to be provided with electricity.

7. The personal safety system of claim 6 said concomitant articulable basis being a decorative light source.

8. The personal safety system of claim 7 said decorative light source being a decorative pattern of lights.

9. The personal safety system of claim 7 said light source emitting a large quantity of infrared light and a smaller quantity of visible light.

10. The personal safety system of claim 7 said light source comprising at least one light emitting diode for producing a large quantity of infrared light together with a moderate quantity of visible light.

11. The personal safety system of claim 10 said light source comprising an array of light sources, said array comprising at least one infrared light emitting diode for producing a quantity of infrared light together with at least one visible light emitting diode for producing a quantity of visible light.

12. The personal safety system of claim 11 said light source further for producing a visible pattern of light for inducing potential assailants to look at said camera.

13. The personal safety system of any of claim 11 said light source further for producing a mesmerizing light chaser pattern for inducing persons to look at said camera.

14. The personal safety system of claim 13, said light source including lights encircling said housing.

15. The personal safety system of claim 1, including a light source, said light source for providing at least two of:
a first function of providing a decorative pattern of light;
a second function of illuminating subject matter in view of said camera;
a third function of wirelessly transmitting data from said camera.

16. The personal safety system of claim 1, including a wireless transceiver, said wireless transceiver for providing at least two of:
a first function of providing a decorative pattern of light;
a second function of illuminating subject matter in view of said camera;
a third function of wirelessly transmitting data from said camera.
a third function of wirelessly transmitting data from said camera.
a fourth function of wirelessly receiving data from another of said personal safetycharms.

17. A personal safety system including the features of claim 1, said personal safety system including a conspicuous annunciator located adjacent to said housing.

18. The personal safety system of claim 17 where said annunciator is a red light illuminated continuously.

19. The personal safety system of claim 17 where said annunciator is a flashing red light.

20. The personal safety system of claim 17 where said annunciator is a flash lamp.

21. The personal safety system of claim 17 where said annunciator functions also as a wireless data transmitter.

22. A personal safety system including the features of claim 1 said personal safety system further including an illuminator for illuminating subject matter in view of said camera., said illuminator also for wireless transmission of picture signals from said camera.

23. A personal safety system including the features of claim 1 said personal safety system further including a pulsed illuminator for providing a brief burst of illumination of subject matter in view of said camera, said illuminator also for wireless transmission of picture signals from said camera.

24. The personal safety system of claim 23 in which said illuminator transmits one picture in each burst of illumination from said illuminator.

25. The personal safety system of claim 23 in which said illuminator transmits using a Picture Transfer Protocol in which each packet of data corresponds to one picture from said camera.

26. A method of providing a personal safety service, for allowing a person or group of persons to articulate external forces that maintain stability, safety, or rationale for not submitting entirely to requests of unaccountable actions such as violence, torture, or unmonitored interaction, said method including the features of claim 1, said method comprising the steps of having a Safety Management Organization:
provide a user of said method with said housing;
allow said user of said method to choose a contract having terms that require said user to wear said housing;
provide said user with at least one task that requires that the user be bound by said terms;
provide said user with means for presenting to entities who request removal of said housing an articulable basis upon which said user is bound by said terms.

27. The method of claim 26, where said method to choose a contract is selection from a menu of contracts, each of said contracts associated with at least one task for which said terms are required of said user.

28. A method of providing a personal safety service, for allowing a person or group of persons to articulate external forces that maintain stability, safety, or rationale for not submitting entirely to requests of unaccountable actions such as violence, torture, or unmonitored interaction, said method including the features of any of claim 1, said method comprising the steps of providing a user of said method with:
said housing;
an insurance policy in which cheaper insurance rates are offered in return for wearing said housing at all times when interacting with other persons;
forms for presenting to entities who request removal of said housing said forms stating an articulable basis upon which said user is required to wear said housing by virtue of said insurance policy.

29. A personal safety system including the features of claim 1, said housing being a briefcase said briefcase including a deterrent, said briefcase having a lock, said lock having two modes of operation:
a first forgettable mode of operation for opening said briefcase without activating said deterrent,
a second mode of operation for opening said briefcase while activating said deterrent.

30. A personal safety system including the features of claim 1, said housing being a briefcase said briefcase including a deterrent device, said briefcase having a lock, said lock having three modes of operation:
a first forgettable mode of operation for opening said briefcase without activating said deterrent device,
a second mode of operation for opening said briefcase while activating said deterrent device,
a third mode of operation for opening said briefcase in response to remote authorization, said third mode not activating said deterrent device.

31. A personal safety system including the features of claim 1, said housing being a briefcase, said briefcase including a deterrent, said briefcase having a lock, said lock having two modes of operation:
a first mode of operation for opening said briefcase without activating said deterrent,
a second mode of operation for opening said briefcase while activating said deterrent,
said first mode of operation requiring remote authorization.

32. The briefcase of claim 31, where said deterrent is an irritant.

33. The briefcase of claim 31, where said deterrent is a noise producing device.

34. The briefcase of claim 31, where said deterrent is a photographic picture taking device, including an electronic flash to repeatedly take pictures of a person searching said briefcase.

35. A personal safety system including the features of claim 1, said housing being a briefcase, for keeping confidential documents, corporate property, business plans, or the like, safe from scrutiny by strangers, while being carried, said conspicuous concealement housing comprising:
a carrying case;
at least one imager borne by said carrying case;
at least one lock,
said imager operable when said case is closed, and said lock responsive to an output of said imager.

36. A method of doing business of personal safety with a user of the carrying case described in claim 35, said method including the steps of:
providing said user with means for forwarding requests from persons wishing to search said carrying case to a Safety Management Organization of said user;
receiving a request at said Safety Management Organization from a person wishing to search said carrying case;
processing said request at said Safety Management Organization;
providing authorization from said Safety Management Organization to said user to open said carrying case,
said user having an articulable basis upon which not to open said carrying case prior to receiving said authorization.

37. The system of claim 35 where said carrying case is a briefcase and where said imager is a fingerprint scanner.

38. The system of claim 37 where said fingerprint scanner includes a shroud to prevent improperly inserted fingers.

39. The system of claim 37 where said fingerprint scanner is a first fingerprint scanner, and further including a second fingerprint scanner located far enough from said first fingerprint scanner that a single hand of a user cannot simultaneously reach both fingerprint scanners, said system having at least one mode of operation in which unlocking said briefcase requires the simultaneous valid scan of at least two fingerprints.

40. The system of claim 39 where said second fingerprint scanner also includes a shroud to prevent improperly inserted fingers, said shrouds both being oriented for positioning a person inserting fingers into the fingerprint scanners such that said person's face is in view of a conspicuously concealed imaging possibility of said conspicuously concealed housing. when said persons fingers are properly inserted into said fingerprint scanners.

41. A personal safety system including the features of claim 1, said housing being a dome made of a material at least partially transparent in a getting to which said camera is sensitive.

42. A personal safety system including the features of claim 1, said housing being a wearable node device in a network, said wearable node device having two modes of operation, a first mode for providing a conspicuously concealed imaging possibility of an environment, and a second mode for providing a conspicuously concealed imaging possibility of a wearer of said wearable node, said first mode for being activated when said wearable node is worn, and said second mode for being activated when said wearable node is removed from a body of a person wearing said wearable node device.

43. A personal safety system including the features of claim 1, said housing being a wearable dome device, said wearable dome device having two modes of operation, a first mode for providing a conspicuously concealed imaging possibility of an environment, and a second mode for providing a conspicuously concealed imaging possibility of a wearer of said dome device said first mode for being activated when said wearable dome device is worn, and said second mode for being activated when said wearable dome device is removed from a body of a person wearing said wearable dome device.

44. A personal safety system including the features of claim 1, said housing being a wearable device having a dome, for being worn with said dome facing forwards or backwards from the body in standing position, said personal safety system including at least one wearable device having said camera, and having two modes of operation, a first mode in which said camera is pointed primarily along an optical axis of said dome, and a second mode in which said camera is pointed primarily in a direction away from said optical axis of said dome, said first mode being activated when said wearable device is worn, and said second mode being activated when said wearable device is removed from a body of a person wearing said wearable device.

45. A personal safety system including the features of claim 1, said housing including a dome aimed in a backward facing direction when worn on a body of a user in a standing position, said personal safety system including at least one housing having a Doppler radar system.

46. A personal safety system including the features of claim 1, said housing including at least one device having a camera aimed in a backward facing direction when worn on a body of a user in a standing position, said device having a radar system providing a complex-valued signal output.

47. A personal safety system including the features of claim 1, said housing including at least one device having a camera aimed in a backward facing direction when worn on a body of a user in a standing position, said device having a radar system and processor for said radar system and said camera, said processor for computing a chirplet transform of data from said radar, said processor for making a decision based on said chirplet transform, said decision being whether or not to capture and display a picture from said camera.

48. A personal safety system including the features of claim 1, said housing including at least one device having a camera in a dome, said camera having a built-in source of light, said device having a telelight extender, said telelight extender comprising a light sensor for covering said built-in source of light, said telelight extender having an external light source for being mounted outside said dome, said external light source being driven in a quantity of light proportional to a quantity of light from said built-in source of light.

49. A personal safety system including the features of claim 1, said housing being a dome with holes drilled around a periphery of said dome, for being sewn onto a garment.

50. A personal safety system including the features of claim 1, said housing being a dome with fasteners around a periphery of said dome, for being sewn onto a garment.

51. A personal safety system including the features of claim 1, said housing being a dome with threaded fasteners around a periphery of said dome, for being sewn onto a garment, said threaded fasteners being secured with a security cable, said security cable being fixed with a tamper evident seal.

52. A personal safety system including the features of claim 1, said housing being a left cup of a garment for being worn on the upper body of a user, said garment also having a right cup, said left cup and right cup being made of an at least partially transparent material.

53. A personal safety system including the features of claim 1, said housing being a sheet of dark transparent material for being sewn onto a garment.

54. A personal safety system including the features of claim 1, at least some of said safety enhancing devices for receiving pictures transmitted by other safety enhancing devices in the personal safety system.

55. A personal safety system including the features of claim 1, said personal safety system including a viral image propagation mode, said viral image propagation mode including a Fear of Funcationality feature.

56. A personal safety system including the features of claim 1, said personal safety system including a safety seed disseminator.

57. A personal safety system including the features of claim 1, said personal safety system further including a display for being viewed by a subject visible by said camera.

58. A personal safety system including the features of claim 1, said personal safety system further including a display for being viewed by a subject visible by said camera and a processor for generating an advertisment in which said subject appears, said advertisment for being displayed on said display.

59. A personal safety system including the features of claim 1, said personal safety system further including a projector for projecting an image for being viewed by a subject visible by said camera.

60. A personal safety system including the features of claim 1, said personal safety system further including a projector for projecting an image for being viewed by a subject visible to said camera, said personal safety system also including means for stabilizing said image of said projector with respect to a projection surface upon which said image is projected.

61. A personal safety system including the features of claim 1, said personal safety system further including a wearable miniature, said miniature for providing theatrical entertainment distraction to a subject being photographed by said camera.

62. A personal safety system including the features of claim 1, said housing comprising a toy, said toy providing entertainment to a subject being photographed by said camera.

63. A personal safety system, comprising:
a plurality of personal safetycharms for being worn by users, each of said plurality of personal safetycharms comprising:
one of:
a fashion accessory including an optical conspicuous concealment housing together with a camera housed in a concealed manner in said conspicuous concealment housing, and a transmitter for transmitting pictures taken by said camera;
a fashion accessory including an optical conspicuous concealment housing lacking a camera;
a communications network including at least one receiver for receiving picture signals transmitted by said camera.

64. A method of enhancing personal safety, comprising the steps of:
providing a plurality of safety enhancing devices to users, each safety enhancing device comprising at least one of each of:
a camera installed in a concealed fashion in a wearable conspicuously concealed imaging possibility housing and a transmitter for transmitting pictures taken by said camera;
a wearable conspicuously concealed imaging possibility housing lacking a camera.
